(19) United States
(12) Patent Application Publication
(10) Pub. No.: US 2004/0033166 A1
(43) Pub. Date: Feb. 19, 2004

(54) Automated robotic device for dynamically controlled crystallization of proteins

(76) Inventors: Leonard Arnowitz, Chevy chase, MD (US); Emmanuel Steinberg, Tel-Aviv (IL); Mark W Sawicki, Fredericksburg, VA (US); Michael T Harris, Lafayette, IN (US); Thomas C.S. Keller III, Tallahasse, FL (US)

Correspondence Address: Richard C Litman, Litman Law Offices, P O Box 15035, Arlington, VA, 22215, US

(21) Appl. No.: 10/381,659

(22) PCT Filed: Sep. 28, 2001
(86) PCT No.: PCT/US01/30454

(51) Int. Cl. G01N 1/00

(52) U.S. Cl. 422/82.05; 436/174

(57) ABSTRACT

Apparatus and methods are provided for independently controlling dynamic, reagent-induced transformations of multiple samples including proteins being crystallized and cells being cultured. The invention provides an automatic robotic device that enhances protein crystallization in high-throughput, using reagent reservoirs (28) linked to reagent chambers (40), with sample chambers (44) communicating with the reagent chambers (40) via semipermeable membrane.

### BACKGROUND OF THE INVENTION

The present invention relates to an automated system using controlled, dynamically changing solution conditions to induce and monitor biological transformations such as crystallizing proteins and growing cells.

There is a pressing need for reliable, high yield, high quality crystallization procedures for rational/structural drug design. Existing screening methods including traditional vapor diffusion experiments, automated systems, and commercial screens are inadequate. For example, once a vapor diffusion experiment is set up with a target concentration of the precipitant used, it cannot be modified. This prolongs the optimization process, and makes it nearly impossible to screen effectively a large number of conditions without a large time commitment and large quantities of protein.

Despite its increasing commercial importance, the science underlying crystal growth is incomplete and it is nearly impossible to predict the conditions under which a newly studied protein will crystallize (Ries-Kautt, M., et al., Inferences drawn from Physicochemical Studies of Crystallogenesis and the Precrystalline State: Macromolecular Crystallography. Methods Enzymol. 1997, 276, 23-59; McPherson, A., Crystallization of Biological Macromolecules: Cold Spring Harbor Laboratory Press: Cold Spring Harbor, N.Y., 1999; Ducruix. A., and Giege R., Eds., Crystallization of Nucleic Acids and Proteins: A Practical Approach; IRL Press: Oxford, United Kingdom, 1992). The process of protein crystal growth can be dissected into primary nucleation, and nucleation and growth of its chemically and geometrically constituent layers and rows. Proteins are typically half water by volume, mechanically fragile, and marginally stable. They are prepared in aqueous solutions and crystals of about 0.2 mm size are usually grown for x-ray diffraction measurements that can lead to detailed structural information. Protein crystals are generally cultivated by slowly dehydrating a solution of the pure protein with a large excess of a selected soluble salt or alcohol called the precipitant, and in addition some lower-concentration co-solutes such as buffers and reducing agents that maintain protein stability. Frequently, crystal growth will display a strong sensitivity to these co-solutes due to interactions with the protein surface. In defiance of systematic science, knowing the conditions that gave crystals for one protein does little to predict conditions for even a closely related protein, and a wide assortment of chemical additives has been found useful for various proteins (Jankarik, T., Kim, S. H. Sparse Matrix Sampling: A Screening Method for Crystallization of Proteins. J. Appl. Cryst. 24, pp. 409-411). Due to these sensitivities and the instabilities of the proteins themselves, the process of protein crystal growth nearly always involves searching and scanning to optimize the results (Cudney, R., et al., Screening and Optimization Strategies for Macromolecular Crystal Growth. Acta Cryst. 1994, D50, pp 414-423.) For a new protein, the initial search phase involves a broad scan covering wide arrays of potential additives to identify those that promote crystal growth. In the subsequent optimization phase, the scanning is localized around the conditions that have been found to produce crystals.

Efforts to produce crystals, and then to optimize them for diffraction and structure determination, typically take months to years. Cystallization of a biological molecule such as a protein involves the creation of a supersaturated solution of the molecule under conditions that promote minimum solubility and the orderly transition of the molecules from the solution into a crystal lattice. The variables that must be controlled precisely to promote crystal growth include temperature, protein solution concentration, salt solution concentration, PH, and gravitational field, for example (Durbin, S., Feher, G., Ann. Rev. Phys. Chem., 1996, 47, pp. 171-204). These variables are carefully controlled and optimum combinations thereof are determined through experimentation to yield superior crystals.

Removal of water from the protein solution is usually effected by vapor diffusion, by dialysis, or by direct mixing with hypertonic media (Weber, P. C. Overview of Protein Crystallization Methods: Macromolecular Crystallography. Methods Enrymol. 1997, 276, pp. 13-22). Dialysis methods use a hygroscopic reservoir to remove water. A polysaccharide semipermeable membrane is utilized that blocks passage of the protein but permits water and precipitant to pass through (in opposite directions). A key practical difference is that in vapor diffusion the (usually nonvolatile) precipitant must be premixed with the protein, whereas for dialysis no premixing step is needed since the precipitant can usually traverse the membrane. Ordinarily the dialysate is not changed (static dialysis) and the precipitant level in the protein chamber increases rapidly at first, then more slowly. If the precipitant concentration rises too quickly, excess nucleation occurs, while if the trajectory is slower, growth of a few crystals may be favored. If the rise in precipitant concentration occurs too slowly, competing processes like protein aggregation and denaturation may interfere. With direct mixing or batch methods, the protein solution is simply mixed with a precipitant solution. This does not formally remove water, but like the other methods, it raises the concentration of precipitant in the protein compartment and thus decreases protein solubility to promote crystal growth.

A DCCS™ dialysis-based reactor for protein crystal growth, featuring dynamic control of the dialysate is described in commonly-owned U.S. Pat. No. 5,961,934, and in International Publication No. WO 99/42191, the contents of which are incorporated herein by reference in their entirety. An embodiment comprises a crystallization chamber that is divided by a semipermeable membrane into two compartments, a reactant chamber and a reagent chamber. The reactant chamber is filled with a reactant solution, e.g., a solution of protein to be crystallized, and the reagent chamber is filled with a reagent solution, e.g., a precipitant solution. The device works by pumping precipitant-rich reservoir solution through the reagent chamber so as to gradually raise the precipitant level experienced by the protein, under computer control. The reagent solution is connected via tubing to a precipitant supply syringe and also to a drain syringe that begins empty.

The existing DCCS™ technology, although an improvement over all prior techniques, is nonetheless time consuming and requires substantial manpower. With the advent of proteomics, and recent advances in cloning methodology, purification techniques, subsequent data collection, and structural determination procedures, a major bottleneck in the structural determination of proteins is the process of protein crystallization. The Protein Structure Initiative has set the goal of crystallizing and determining the structures of 10,000 proteins in the next 10 years. For the Protein Structure Initiative to be a success, novel crystallization procedures are required to permit the structural determination of a large number of proteins in a high throughput mode. There is therefore a strong need for a crystallization system that allows many independent crystallization conditions to be simultaneously screened and dynamically controlled, with minimal repetition, to improve the screening process and enable crystallization of a large number of proteins independently, and quickly, using parallel processing.

With so many important proteins to be crystallized, there is a need for automation of the crystallization experiments. Robotics enables systematic pipetting of solutions and protein into crystal growth chambers on plates, so that a multiplicity of conditions can be examined more quickly and consistently. The use of robotics provides accuracy and frees valuable time for researchers. Another trend is the use of semi-automated techniques to record results. However, these steps do not avoid the bottleneck of the crystallization process itself.

Protein structure research requires not only diffractable protein crystals, but also protein crystals soaked in solutions of heavy atoms, to allow the heavy atoms to bind to the crystallized protein molecules. The resulting heavy atom derivative is useful in obtaining the phase solution needed to determine the structure of the protein. Problems arise because the heavy atom compounds may damage the crystal if present at too high a concentration. In addition, the heavy atom compounds often have low solubility, and so must be used at low concentrations that are barely above the minimum concentration permitting effective binding to the protein. Therefore, as the heavy atom compounds bind the protein and come out of solution, the effective concentration is reduced and further binding is curtailed. Static solutions are typically used to make heavy atom derivatives. It is impossible to predict the optimal concentration of heavy atom to use, and much time and protein are lost in determining solution conditions that are suitable for producing heavy atom derivatives. A dynamic high throughput method of heavy metal binding is needed.

Similar problems arise in efforts to bind ligand and drug molecules to crystallized protein molecules in situ. If the concentration of ligand or drug is too high, it may damage the crystal, however, if it is too low, the ligand or drug will not bind to the protein molecules. As with heavy atoms, the low solubility of many ligand and drug molecules compounds the problem.

Dynamic dialysis devices may help by permitting the concentration of heavy atom compound, ligand, or drug to be gradually increased in a controlled manner. By observing the crystal through a transparent side of the crystallization chamber, damage to the crystal might be detected at an early stage, and the concentration of heavy atom compound, ligand, or drug lowered accordingly. By constantly refreshing the reactant solution, the concentration of heavy atom compound, ligand, or drug can be held constant, even though molecules leave solution upon binding to the protein molecules. However, to test a large number of different combinations of proteins and reactant solutions to produce crystals, heavy atom derivatives, or in situ complexes of crystallized protein and ligand or drug, insuperable difficulties are encountered in attempting to monitor the states of the samples in each reactant chamber, and to adjust the concentration of reagent in response to the observed states of the samples. The more samples that are screened, and the more closely the samples are monitored, the greater the difficulties encountered. There is thus a need for an improved, automated system for dynamically controlled crystallization of proteins by dialysis.

Another problem in the prior art relates to the use of static assays in determining the responses of cultured cells to various concentrations of biochemical signals such as hormones, cytokines, growth factors, as well as to known and potential drugs. The cells may respond non-linearly, making it likely that selected static concentrations fail to identify the optimal concentration for eliciting the response of interest. When the response of interest is associated with a change in cellular appearance, close monitoring may be necessary to detect the onset of the change. A dynamically controlled system could permit the concentration of the biologically active reactant to be raised gradually, to identify the optimal concentration required for response; but the more samples screened, and the more closely the samples are monitored, the greater the difficulties encountered in monitoring the samples and adjusting the reagent concentrations as needed. There is a need for a controlled robotic system for such monitoring and adjusting.

### SUMMARY OF THE INVENTION

There is a long felt and fast-growing need for superior protein crystallization technology, to keep pace with the proteomics revolution and drug discovery efforts.

This invention succeeds where previous efforts at dynamic control of reagent concentrations and monitoring of effects have failed, and solves previously unrecognized problems in controlling dynamic crystallization of proteins and growth of cells. In particular, the invention solves the problem of high-throughput, robotic protein crystallization, previously thought to be insoluble. This invention omits the need for manual oversight of crystallization status such as nucleation, substituting digital, automatic, sensing and control, without loss of ability.

This invention differs from the prior art in modifications of features of the inventive apparatus and methods, including smaller sample chambers, improved sensing, and in adding novel features such as a feedback control system, which were not previously known or suggested.

This invention provides advantages that were not previously appreciated, including usefulness for heavy metal and ligand binding. The invention is contrary to the teachings of the prior art calling for series arrangements of reaction chambers.

The present invention relates to large-scale screening to detect and modulate state transformations driven by controlled, dynamically changing solution conditions. Such state transformations include the formation of crystals of small and large molecules, including macromolecules such as proteins and nucleic acids, the binding of heavy atoms to crystallized protein molecules in multiple isomorphous replacement, and the in situ binding of ligands and drug molecules to crystallized protein molecules. They also occur when cells change their growth pattern, state of differentiation, metabolism, or physiology, in response to a change in the composition of their medium. In particular, the present invention relates to a method and apparatus for independently effecting and controlling such state transformations in many different samples at the same time.

According to the invention, it is possible to control the equilibration process during crystallization, and monitor the results using digital technologies. The inventive system provides the ability to optimize many (e.g. 100) different conditions the first time they are set up for crystallization. The system permits control of the rate of equilibration through a series of micro-pumps interfaced to a computer, and as changes to the protein solution are observed, the system is able to slow down, pause, halt, and in some cases, reverse the process. This control greatly reduces the period of time required to effectively screen each crystallization condition, and minimizes the need to repeat the screening process due to precipitant concentrations being too extreme.

The invention improves over the existing technology in many ways. It permits optimizing the rate of pumping with respect to crystal growth, improving the monitoring of the crystallization process through use of digital imaging hardware.

The invention provides the capability, in the form of apparatus and method, for independently controlling dynamic, reagent-induced transformations of a large number of samples. The invention can be used to automatically or remotely monitor and control a large number of dynamic dialysis reactions of reagents with reagent-sensitive samples in real time. These reactions may include molecular crystallization processes, heavy atom derivative formation processes, and reactions forming complexes of ligand or drug with crystallized protein.

The invention permits automatic or remote control of initiation, termination or reversal of a large number of molecular crystallization processes. The invention can optimize the time required to produce large, well-ordered molecular crystals of a large number of proteins while performing fewer experiments and using substantially less protein.

The present invention can further be used to automatically or remotely monitor and control large numbers dynamic dialysis reactions of reagents with reagent-sensitive cells in real time.

The dynamic dialysis reactions of the invention operate under conditions of real and simulated gravity in the range of from about zero times the earth's gravitational field to about 20 times the earth's gravitational field, and produce crystals in earth's gravitational field, with identical apparatus.

“Controlled dynamic dialysis,” and “controlled, reagent-induced transformation of a sample,” as used herein occur in a system comprising a plurality of individual dynamic dialysis unit, the system permitting: (1) controlling the initial introduction of reagent into a reagent chamber of a dynamic dialysis unit, and maintaining control over the concentration of reagent in the reagent chamber i.e. increasing or decreasing at will; (2) monitoring physical or chemical attributes of a reagent-sensitive sample in the sample chamber; (3) analyzing data collected by monitoring the sample chamber and making decisions regarding altering the conditions in the sample chamber based upon the data from monitoring; (4) precisely controlling the conditions in the sample chamber throughout the dialysis process, and independently modifying, stopping, or reversing the dialysis process in each dialysis unit when desired.

The present invention provides a method for independently controlling dynamic, reagent-induced transformations of multiple samples. The upper limit of the number of samples with which the invention operates successfully is determined by the resources available—the invention may be operated successfully with about 10, about 100, or 1000 or more samples.

One aspect of the invention is practiced with multiple dynamic dialysis units, each of which is divided into two compartments, a sample chamber and a reagent chamber, which are separated by a semipermeable membrane. A sample is placed into the sample chamber of each unit, and the reagent chamber of each unit is filled with a reagent solution. Each reagent chamber is connected by a fluid conduit to a reagent reservoir that contains reagent solution containing a selected concentration of a reagent of interest, and is also connected to a second fluid conduit that can serve as a drain.

Fluid transfer mechanisms are controlled to transfer a selected volume of reagent solution from a reagent reservoir into the reagent chamber of each unit. As the reagent solution is transferred into the reagent chamber, an equal volume of solution leaves said reagent chamber via the second conduit. The reagent of interest then diffuses across the membrane and into the sample chamber of each unit, at a rate that is dependent on the concentration gradient present across the membrane in each unit.

Another aspect of the invention is that a sensor is controlled to sense the state of the sample in each dialysis unit. The sensor can sense a change in one or more physical or chemical attributes of said sample in said sample chamber, and produces an output signal conveying the results of the sensing operation.

In another aspect of the invention an analyzer is controlled to receive and analyze the output signals produced by the sensor. The control system may cyclically, with a predetermined frequency, transfer a predetermined volume of reagent solution into the reagent chamber of each unit, sense the state of the sample in the sample chamber of each unit, and analyze the sensor output to determine if the sensor has detected a change in the sample that is associated with transformation of said sample to a predetermined target state. Upon determining that the sensor has detected such a change in the sample, a controller initiates a feedback response to control the fluid transfer mechanisms to regulate the flow of reagent solution between the reagent reservoir and the reagent chamber of the dynamic dialysis unit containing the sample.

The present invention provides an apparatus comprising multiple dynamic dialysis units, each of which contains a reagent chamber and a sample chamber. The reagent chamber of each unit is connected to at least one reagent reservoir containing a reagent solution, and each unit also has a drain, which may be in the sample chamber. The unit is designed to accept a semipermeable membrane that serves to separate the reagent and sample chambers. The apparatus includes a fluid transfer mechanism that transfers reagent solution between the reservoir and the reagent chamber, and at least one sensor that can sense one or more physical or chemical attributes of a sample in the sample chamber of each unit, and produce a corresponding output signal. A main control system controls the transfer of reagent solution between the reagent reservoir and each dialysis unit, and it controls the sensor. The main control system comprises (i) a sensor control system that receives the output signal from the at least one sensor and controls the operation of the sensor, (ii) an analysis system that analyzes output signals received from the sensor, and (iii) a dynamic dialysis unit control system that independently controls the flow of reagent solutions between the reagent reservoir and each dynamic dialysis unit. The main control system independently controls the flow of reagent solution from said reagent reservoir to the reagent chambers of the dynamic dialysis units, and modifies the flow in feedback response to the output signal from the analysis system.

In an embodiment of the invention, the sample is a protein and the sensor detects a stage of crystallization. In another embodiment, each dynamic dialysis unit is supported on a rotatable, circular array. Alternatively, the apparatus can comprise a movable, x-y table to which each dynamic dialysis unit is attached in one or more rows. To facilitate sample monitoring, each of the dynamic dialysis units can comprise. a transparent wall through which the interior of said sample chamber can be viewed, and a preferred system for sensing comprises a camera mounted on a microscope. Alternative means for sensing the state of the sample that are useful when the system is used for growing crystals are sensors that measure; one or more of static laser light scattering, dynamic laser light scattering, small-angle X-ray scattering, ultra-small-angle X-ray scattering, and small-angle neutron scattering, in the sample chamber of a selected disc dialysis unit, and an interferometer.

The invention permits the direction of flow of fluid between the reagent reservoir and the reagent chamber of each of said dynamic dialysis units to be independently reversible, and further provides a second fluid transfer mechanism that transfers fluid between the reagent clamber and the drain reservoir of each dynamic dialysis unit. The fluid transfer mechanisms can be controllable to simultaneously transfer equal volumes of solution into and out of the reagent chamber. In one embodiment, the reagent reservoir is connected via tubing to both the inlet and drain of the reagent chamber to form a closed system. The reagent reservoirs and fluid transfer mechanisms may be provided by paired syringes mounted to point in opposite directions, with their plungers clamped together. At least one syringe is filled with a reagent solution and both are connected via tubing to the reagent chamber. A motor is connected to the interlocked plungers and to a controller, and controlling the motor to move the plungers causes solution to be transferred from one syringe into the reagent chamber, and an equal volume of solution to flow out of the reagent chamber towards the other syringe. The apparatus may have from 2 to 1000 dynamic dialysis units, preferably from about 10 to about 500 dynamic dialysis units, and more preferably about 100 dynamic dialysis units. The volume of the sample chamber of each dynamic dialysis unit maybe from 0.1 to about 100 microliters, from 0.1 to about 10 microliters, or from about 0.1 to about 3 microliters. The volume of the reagent chamber of each dynamic dialysis unit may be from about 20 microliters to about 10 milliliters, or from about 50 to about 100 microliters.

An apparatus comprises (a) at least one means for containing a reagent solution comprising at least one reagent; (b) a plurality of means for dynamically dialyzing a sample, each comprising: (i) means for containing a sample solution; (ii) means for controlledly contacting said reagent solution with the sample solution, whereby at least a component of said reagent solution is selectively transferred from the reagent solution to the sample solution, or a component of said sample solution other than the sample is selectively transferred from the sample solution to the reagent solution; (c) at least one means for transferring fluid from the reagent solution containing means to said means for placing the reagent solution in controlled contact with the sample containing means, and at least one means for transferring fluid away from said means for placing the reagent solution in controlled contact with the sample containing means, for each dynamic dialysis means; (d) at least one means for sensing a change in one or more physical or chemical attributes of the sample in the sample containing means, and for producing an output signal; (e) means for dynamically controlling the concentration of said at least one reagent in each sample containing means over time, comprising: (i) means for independently controlling the flow of reagent solution between said reagent containing means and the means for placing the reagent solution in controlled contact with the sample containing means, of each of said dynamic dialysis means; (ii) means for analyzing output signals received from said sensor means for each of said dynamic dialysis units, and (iii) means for modifying the flow of reagent solutions of each of said dynamic dialysis units in response to said output signals received from said sensor means.

A method comprises (a) providing a reagent solution comprising at least one reagent in a first reagent reservoir; (b) providing a solution comprising an initial reagent in a reagent chamber of each of a plurality of dynamic dialysis units comprising a reagent chamber and a sample chamber; wherein said reagent chamber communicates via a first fluid conduit with said reagent reservoir, and has a second fluid conduit; and wherein at least one first fluid transfer mechanism transfers fluid between said first reagent reservoir and the reagent chamber via said first conduit, for each dynamic dialysis unit; (c) loading a sample solution comprising a sample into the sample chamber of each of said dynamic dialysis units; wherein each of said dynamic dialysis units further comprises a semipermeable barrier between said reagent chamber and said sample chamber that contacts and separates said sample and reagent solutions in said unit; (d) performing the following steps independently for each of said dynamic dialysis units, transferring a predetermined volume of reagent solution into the reagent chamber from said reagent reservoir, and simultaneously transferring an equivalent volume of solution out of the reagent chamber, and after a predetermined period of time following step (i), sensing the state of the sample in said sample chamber with at least one sensor that can sense one or more physical or chemical attributes of said sample in said sample chamber, and producing an output signal conveying the results of the sensing operation; and analyzing the output signals received from said at least one sensor, and determining if the sensor has detected a change in a physical or chemical attribute of said sample that is associated with transformation of said sample to a predetermined target state; repeating steps (i) to (iii) above until it is determined in step (iii) that said sample is transformed into a sample having a predetermined target state; and independently controlling the flow of reagent solution between the first reagent reservoir and the reagent chamber of said dynamic dialysis unit containing a sample having a predetermined target state, in feedback response to the sensing of said state of said sample by the sensor.

The fluid transfer may comprise pumping. The method may involve controlling the position of the sensor relative to the position of each of said dynamic dialysis units by a position control system, for example wherein the sample chamber and the reagent chamber of each dynamic dialysis unit are supported by at least one support structure that is operably connected to the position control system, and the support structure places the sample chamber of a selected dynamic dialysis unit at the sensor. Or the method comprises positioning at least a sensing portion of said sensor by the position control system to sense the sample in the sample chamber of a selected dynamic dialysis unit.

The analyzing the sensor's output signal may comprise processing said signal and determining whether the state of the sample sensed by said sensor has changed its properties. The method may comprise: (i) independently controlling the flow of reagent solutions between said first reagent reservoir and said reagent chamber, and between the reagent chamber and the second fluid conduit, of each dynamic dialysis unit, (ii) controlling the position of the sensor relative to the position of each of said dynamic dialysis units; (iii) controlling the operation of said sensor, (iv) analyzing output signals produced by said sensor, and (v) feedback controlling the dynamic dialysis unit control system in response to the output signal from the analysis system.

The output signal may correspond to the state of said one or more physical or chemical attributes of the sample sensed by said sensor. The reagent solution may comprise heavy atoms, and said predetermined target state comprises the binding of protein molecules of said crystal to said heavy atoms, or the reagent solution comprises ligand molecules that bind to a molecule of said protein, and the target state comprises the binding of said crystallized protein molecules to said ligand molecules, or the reagent solution comprises drug molecules that bind to a molecule of said protein, and said predetermined target state comprises the binding of said crystallized protein molecules to said drug molecules. The sample may comprise cells such as cancer or blood cells and the target state may be a change in at least one of the growth pattern, state of differentiation, metabolism, or physiology, of said cells in response to said reagent, such as a drug.

Embodiments include reversing the direction of fluid flow, transferring fluid between said second reagent reservoir and the reagent chamber via said second conduit, for each dynamic dialysis unit. The sensing may comprise obtaining a photographic image of a magnified view of the cells in the interior of a sample chamber, or assaying reagent solution of the reagent chamber to detect a chemical signal produced by said cells in response to said reagent.

An embodiment involves the concentration of precipitant in said first reagent reservoir being greater than its concentration in said second reagent reservoir; where the feedback response to sensing nucleation in the sample chamber of a dynamic dialysis unit comprises reversing the direction of flow of reagent solution between the reservoirs.

A method for independently controlling dynamic, reagent-induced transformations of multiple samples, comprises: (a) a step for introducing a reagent solution comprising at least one reagent into a first reagent reservoir; (b) a step for introducing a solution comprising said reagent into a reagent chamber of each of a plurality of dynamic dialysis units comprising a reagent chamber and a sample chamber; wherein said reagent chamber communicates via a first fluid conduit to said reagent reservoir, and further communicates with a second fluid conduit; and wherein at least one first fluid transfer mechanism transfers fluid between said first reagent reservoir and the reagent chamber via said first conduit, for each dynamic dialysis unit; (c) a step for introducing a sample solution comprising a sample into the sample chamber of each of said dynamic dialysis units; wherein each of said dynamic dialysis units further comprises a semipermeable barrier between said reagent chamber and said sample chamber that contacts and separates said sample and reagent solutions in said unit; and independently performing for each of said dynamic dialysis units:

(i) a step for transferring a predetermined volume of reagent solution into the reagent chamber from said reagent reservoir, and simultaneously transferring an equivalent volume of solution out of the reagent chamber;

(ii) a step for detecting a change in a physical or chemical attribute of said sample that is associated with transformation of said sample into a sample having at least one predetermined target state;

(iii) a step for independently controlling the flow of reagent solution between the first reagent reservoir and the reagent chamber of said dynamic dialysis unit containing a sample having a predetermined target state, in feedback response to the sensing of said state of said sample by the sensor.

A method for independently controlling dynamic, reagent-induced transformations of multiple samples of cultured cells comprises (a) placing a reagent solution comprising cell culture medium comprising nutrients required by the cells and a reagent of interest into a first reagent reservoir; (b) placing cell culture medium comprising nutrients required by the cells into a reagent chamber of each of a plurality of dynamic dialysis units comprising a reagent chamber and a sample chamber; wherein said reagent chamber communicates via a first fluid conduit to said reagent reservoir, and further communicates with a second fluid conduit; and wherein at least one first fluid transfer mechanism transfers fluid between said first reagent reservoir and the reagent chamber via said first conduit, for each dynamic dialysis unit; (c) placing cell culture medium comprising nutrients required by the cells into the sample chamber of each of said dynamic dialysis units, and inoculating said chambers with cells; wherein each of said dynamic dialysis units comprises a semipermeable barrier between said reagent chamber and said sample chamber that contacts and separates said cell-containing solution in said sample chamber from said cell medium in said reagent chamber in said unit; and (d) performing the following steps independently for each dynamic dialysis unit: (i)transferring a predetermined volume of reagent solution into the reagent chamber from said reagent reservoir, and simultaneously transferring an equivalent volume of solution out of said reagent chamber and into said second conduit; (ii) after a predetermined period of time following step (i), sensing the state of the cells in said sample chamber with at least one sensor that can sense a change in one of the growth pattern, state of differentiation, metabolism, or physiology, of said cells in said sample chamber, and producing an output signal conveying the results of the sensing operation; (iii) analyzing the output signals received from said at least one sensor, and determining if the sensor has detected a change in said cells that is associated with said cells being transformed to have at least one predetermined target state; (iv) repeating steps (i) to (iii) above until it is determined in step (iii) that said cells are transformed to have a predetermined target state; and (v) independently controlling the flow of reagent solution between the first reagent reservoir and the reagent chamber of said dynamic dialysis unit containing a sample having said at least one predetermined target state, in feedback response to the sensing of said state by the sensor.

### BRIEF DESCRIPTION OF THE DRAWINGS

FIG. 1 is a schematic depiction of a general embodiment of the invention.

FIG. 2 is a flow chart depicting control of the general embodiment of the invention.

FIG. 3 is a schematic view of a carousel embodiment of the invention.

FIG. 4 is an elevation of an x-y table embodiment of the invention.

FIG. 5 is a side view of an x-y table embodiment of the invention.

FIG. 6 schematically depicts a 12 crystallization chamber strip.

FIG. 7 is a top view of an x-y table embodiment of the invention having several rows of reaction chambers.

FIG. 8 is a top view of a carousel embodiment of the invention.

FIGS. 9-12 illustrate a second carousel embodiment of an automated robotic device for dynamically controlled crystallization of proteins in accordance with the invention.

FIG. 9 is a top view of a second carousel embodiment of the invention.

FIG. 10 is an elevation of the second carousel embodiment.

FIG. 11 is a side view of the reservoir subsystem 408 of the second carousel embodiment.

FIG. 12 is a top view of a reaction unit (sample chamber/reagent chamber) subassembly, mounted in a carousel embodiment of the invention.

FIG. 13 is a side view of a reaction unit (sample chamber/reagent chamber) subassembly, dismounted.

FIG. 14 shows the arrangement for a laser light scattering nucleation detection sensor according to the invention.

FIG. 15 is a digital microscopic image of protein crystals grown in crystallization chambers according to the invention, viewed through the observation window.

FIG. 16 is a schematic illustration of a plurality of dialysis assemblies wherein each dynamic dialysis unit is connected to a separate pair of source and drain reagent reservoirs, with a separate fluid transfer mechanism for each reservoir.

FIG. 17 is a schematic illustration of a plurality of dialysis assemblies wherein each dynamic dialysis unit is connected to a single, separate reagent reservoir and fluid transfer mechanism.

FIG. 18 is a schematic illustration of a plurality of dialysis assemblies, wherein multiple dynamic dialysis units are connected via a valve to a single, common reagent reservoir and a single fluid transfer mechanism.

FIG. 19 is a schematic illustration of a plurality of dialysis assemblies, wherein multiple dynamic dialysis units are each connected to a separate fluid transfer mechanism, each of which in turn is connected to a single, common reagent reservoir.

FIG. 20 is a schematic illustration of a subsupport platform on which are mounted multiple dialysis units, and of a carousel support disc on which the subsupport platform can be removably attached.

FIG. 21 is a schematic view of a dialysis unit that is designed to permit two different reagent solutions to be added through separate conduits into the reagent chamber.

### DETAILED DESCRIPTION OF THE INVENTION

While specific embodiments and preferred methods and materials of the invention are described herein, the invention is not limited to the particular methodology, protocols, and materials described. It is understood that methods, materials, and devices similar or equivalent to those described herein can be used successfully in the practice or testing of the present invention, and that the present invention as described herein is capable of further modifications. This application is intended to cover any variations, uses, or adaptations of the invention following, in general, the principles of the invention and including such departures from the present disclosure as come within known or customary practice within the art to which the invention pertains and as may be applied to the essential features set forth herein and as follows in the scope of the appended claims. All publications, patents, and patent applications mentioned herein are incorporated by reference for the purpose of describing and disclosing the materials and methodologies which are reported in the publications, patents, and patent applications, which might be used in connection with the invention.

Unless defined otherwise, all technical and scientific terms used herein have the same meaning as commonly understood by one of ordinary skill in the art to which this invention belongs. It must also be noted that as used herein and in the appended claims, the singular forms “a”, “and,” and “the” include plural reference unless the context clearly indicates otherwise. For example, reference to “a molecule to be crystallized” includes a plurality of such molecules.

The term “sample” as used herein refers to any entity or system of interest that is subjected to dynamic dialysis according to the invention. For example, the sample may be a molecule such as a protein, it may be a molecular complex such as a ribosome or a myosin complex, or its constituents, it may be a group of metabolically related enzymes, or a cell or tissue sample of interest.

The term “reagent” as used herein refers to a chemical compound that has the potential to affect the state of the sample. For example, it can refer to a precipitant that can affect the solubility of a protein, to a heavy atom compound or a drug or ligand molecule that can affect quality of a protein crystal, or to a compound that can affect the growth pattern, state of differentiation, metabolism, or physiology, of a cell.

The term “reactant” as used herein refers to chemical entity of interest that is used as a sample. A reactant may be a protein, a nucleic acid, or a carbohydrate, it may be a set of different independent molecules, a molecular complex, or a crystallized molecule. For example, a molecule that is being crystallized may be referred to as a reactant.

The term “precipitant” as used herein refers to chemical compounds which affect the solubility of the molecules being crystallized and which, depending on their concentration, can promote or inhibit crystal growth in crystallization processes. Examples of chemical compounds that are precipitants are salts, alcohols, pH modifiers, polyethylene glycol, and small organic molecules (Durbin, S. & Feher, G., Ann. Rev. Phys. Chem. (1996) 47:173). The invention can use any commercially available protein crystallization screens and a plurality of buffers and precipitants, or those later developed. Examples of such commercially available protein crystallization kits are Hampton Research's Crystal Screen™ and Crystal Screen 2™ and Emerald BioStructuers' Wizard I and II. These kits provide over 200 different, proven effective conditions and include the following precipitants: 2-methyl-2,4-pentanediol (MPD), Potassium Sodium Tartrate tetrahydrate, Ammonium Sulfate, mono-Ammonium dihydrogen Phosphate, Polyethelene glycol, Sodium Formate, mono-Sodium dihydrogen phosphate, Jeffamine M-600 ®, 1,4-butanediol, 2-propanol, ethanol, Sodium Citrate, or Sodium Chloride (Jancarik et al. (1991) Sparse-matrix sampling—a screening method for crystallization of proteins. J Appl. Cryst. 24:409)

The term “sample solution” as used herein refers to a solution containing a sample; similarly, the term “reactant solution” as used herein refers to a solution comprising a reactant, and the term “reagent solution” as used herein refers to a solution comprising a reagent.

To “sense” according to the invention includes monitoring physical or chemical characteristics of a sample in order to determine whether any transformation to a target state has occurred. The monitoring may employ any suitable instrumentation or techniques known in the art.

A “dynamic dialysis unit” according to the invention is the individual unit comprising essentially the sample chamber and the reagent chamber fluidly connected via a semipermeable membrane, together with fluidics and controls. Although the term dialysis is used for convenience, it is also contemplated that other membranes and processes may be employed, e.g. with cell growth. An individual dialysis unit may include its own reagent reservoir, drain reservoir, and/or sensor, or may share one or more of them with one or more other units. The related terms Experimental Apparatus, crystallization chamber, reservoir assembly, and other terms are also used here co-extensively with each other.

As used here, a “fluid conduit” encompasses any inlet or drain of a chamber together with any tubing or the like that might be necessary to connect such inlet or drain to a reservoir.

The term automated robotics device is intended to encompass the various embodiments here, including the carousel and x-y table, and others. The fluid transfer mechanisms are described variously as having a syringe, pump, or micropump and it should be understood that such structures may be interchanged.

In the description of the invention that follows, the molecule being crystallized, e.g., the protein, (or cell being analyzed) is referred to as a “reactant,” and the solution containing one or more precipitants that is used in crystallization or biological processes is referred to as a “reagent” solution.

The crystallization process generally involves three distinct phases; nucleation, sustained crystal growth, and termination of crystal growth. Nucleation is the initial formation of an ordered grouping of a few reactant molecules and requires a particular concentration of reactant molecules in a precipitating reagent solution. On the other hand, the continued growth phase consists of the addition of reactant molecules to the growing faces of the crystal lattice and requires lower concentrations of reagent solution than the nucleation phase. The termination phase can be initiated by poisoning the growing lattice with denatured or chemically modified reactant molecules or with different molecules, by depletion of the reactant solution, or by changing the concentration of precipitant to a specified level.

It is considered desirable to obtain a small number of crystallization nuclei quickly that will grow slowly into full-sized crystals. Theoretically, this allows for a relatively large size of the resulting crystals, homogenous crystal order and morphology, and balanced crystal dimensions. Therefore, it is desirable to begin crystallization with a reagent solution containing a particular concentration of precipitant until nucleation is detected, at which point it is desirable to adjust the concentration of precipitant. Thus, one of the critical requirements of any molecular crystallization process is the fine and dynamic control of the various parameters that determine the concentration of the precipitant in the solution in which the target reactant molecule protein is suspended. This control requires the ability to attain nucleation conditions and the ability to modify the concentration of the precipitant without disturbing the crystallization process.

Automated Robotic Device—Design Principles and Key Features

An automated robotic dynamic dialysis system includes a computer and an interface box which can control up to 100 or more separate dynamic dialysis units. The dynamic dialysis unit employs a sample chamber that contains the sample (e.g., a protein to be crystallized) in a solution separated from a reagent chamber that contains a reagent (e.g., precipitating) solution by a dialysis membrane. A computer-controlled mechanism gradually changes the strength of the precipitating solution in a precisely controlled manner and thereby causes the protein to nucleate, and come out of solution. In one embodiment, motor-driven syringes are controlled to direct the transfer of reagent solution into each dynamic dialysis unit. The dynamic control of the system provides the following features:

The introduction of reagent into the sample chamber of each unit can be started at will;

Conditions that are important for determining the state of the sample (e.g. crystal growth) can be monitored;

The conditions can be precisely controlled throughout the dialysis process;

The conditions in each dynamic dialysis unit can be changed automatically and remotely in response to observed changes in the state of the sample therein, including stopping or reversing.

Great advantages are provided by the ability to treat each condition independently, to monitor each condition using a high magnification digital microscope or other sensor, and to control the gradient applied to the sample to permit the experiment to be stopped at any concentration of reagent desired. In crystallography, the invention provides a measure of control and allows a precision not possible using vapor diffusion, or microdialysis, in which a target precipitant concentration is selected at which the protein solution will arrive, and equilibration cannot be stopped once it has been started. This innovation decreases the amount of time required for optimization of the crystallization process, and allows optimization to occur in 100 (or more) different conditions at once. As used herein the term “crystallization chamber” refers to a dynamic dialysis unit that is being used to crystallize a sample molecule, e.g., a protein.

The invention utilizes an optical monitoring system to monitor and detect the onset of nucleation, and can use either micropumps or stepping motors to control the flow of solutions into and out of the reagent chambers. In an embodiment employing the system for crystallization, the system comprises 100 crystallization chambers, and can test 100 different sets of conditions for promoting crystal growth. In a preferred embodiment, the invention is used to identify conditions leading to crystallization of a protein that has not previously been crystallized (e.g. mouse 2B4, an NK cell surface receptor). Accordingly, the invention can facilitate the determination of protein structures for both the Protein Structure Initiative, and commercially, for particular targets of interest in developing compounds with pharmaceutical activity.

The invention provides the following advantages:

A) A Large Array of Crystallization Chambers is Employed, Permitting Crystallization Conditions to be Determined for Many Different Proteins at Once, or Permitting Crystallization of a Single Protein by Many Different Precipitant Solutions.

The precipitant conditions to which the protein is subjected can be altered by changing the solution concentrations. This controls the rate at which the protein nucleates and comes out of solution. In one embodiment, the automated robotic device comprises 100 crystallization chambers, permitting 100 different sets of conditions to be tested simultaneously. The invention is particularly useful for identifying conditions for growing crystals of a large number of proteins which have never been crystallized before using available screens.

B) The State of the Sample in Each Crystallization Chamber is Monitored so that When Early Stages of Crystal Growth are Detected, the Concentration of Precipitant in the Crystallization Chamber Containing that Sample can be Adjusted Accordingly.

In one embodiment, nucleation that signals the onset of crystallization is detected by magnifying a view of the interior of each crystallization chamber through a microscope. As soon as crystal growth is detected, the pumping is stopped and the crystals are left to grow.

C) The Quantities of Protein Required are Minimized.

With the present invention, the total quantity of protein required to obtain good quality crystals is reduced by avoiding the need to repeat screening trials due to protein precipitation in many of the screening conditions directly related to excessive salt concentrations. Also, the crystallization chambers of prior DCCSTM units were designed with a 40 to 50 microliter sample chambers. Recognizing the desirability of using smaller quantities of protein (cost and availability), a series of smaller quantity crystallization chambers were built and tested. Devices according to the invention are able to crystallize protein quantities as low as 2-3 microliters, and even as little as 1 microliter, of protein solution. Accordingly, using the present invention, crystallization trials can be run on a routine basis using only 1 to 10 microliters of protein solution, and preferably 1 to 5 microliters of protein, and most preferably, 2-3 microliters of protein solution, in each crystallization chamber.

E) The Optimizations are Conducted in Parallel Rather than in Series.

Parallelism is designed into the system. This permits individual control of each dynamic dialysis unit (experimental unit). Thus, each dialysis unit may test a different, chemically distinct reagent solution, whereas a series system can only provide different concentrations of the same reagent solution.

Generalized Embodiment

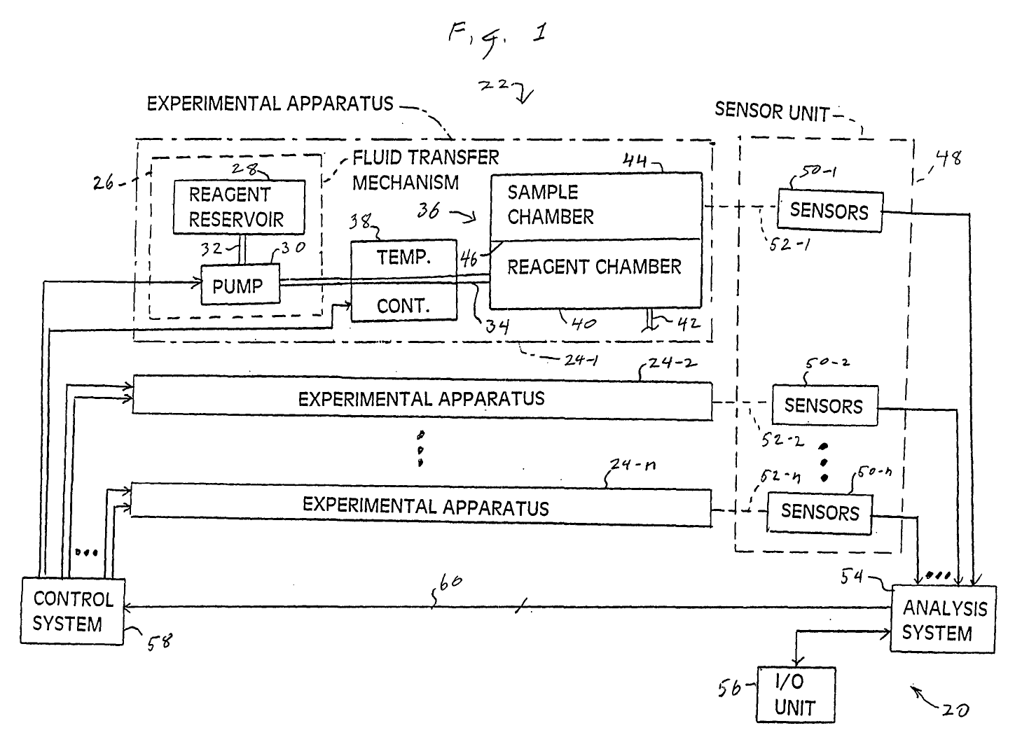

A generalized first embodiment of an apparatus 20 in accordance with the present invention includes an array 22 of experimental apparatuses (dynamic dialysis units). The array 22 that is illustrated in FIG. 1 shows only experimental apparatuses 24-1, 24-2, and 24-n, but it will be apparent that array 22 is not limited to three experimental apparatuses. The three dots shown in FIG. 21 between apparatuses 24-2 and 24-n are intended to indicate that more experimental apparatuses are preferably present in actual practice. There maybe 6, 12, 16, 60, 96, 100 or any other suitable number as described herein.

The experimental apparatus 24-1 includes a fluid-transfer mechanism 26 having a reagent reservoir 28 that supplies a liquid reagent to an electrically operated pump 30 through a conduit 32, which may be narrow diameter, flexible tubing. The fluid transfer mechanism 26 is connected by a conduit 34 to dynamic dialysis unit 36. A temperature controller 38 is provided to control the temperature of the reagent that is pumped from mechanism 26 to the unit 36. The temperature controller 36 may comprise, for example, one or more Peltier devices or resistive heating elements. Although the temperature controller 38 is shown in FIG. 1 as only controlling the temperature of fluid entering the unit 36, it preferably includes Peltier device(s) and/or resistive heating element(s) that are mounted on or near the unit 36 so as to regulate the temperature of the fluid that is actually present in unit 36, compensating for any gain or loss of heat after the fluid enters unit 36.

The dynamic dialysis unit 36 includes a reagent chamber 40 that receives the fluid reagent from conduit 34, the reagent being drained from the chamber 40 via a conduit 42. Although not shown, a valve may be provided in conduit 42 in order to control the flow rate of reagent from the chamber 40. The unit 36 also includes a sample chamber 44 that communicates with the reagent chamber 40 via a semipermeable membrane 46, which provides a contact point between the chambers 40 and 44.

The remaining experimental apparatus of array 22, including the experimental apparatuses 24-2 and 24-n that are shown in FIG. 1, have the same construction as experimental apparatus 24-1.

With continuing reference to FIG. 1, the apparatus 20 also includes a sensor unit 48 for sensing conditions in the array 22 of experimental apparatuses. The sensor unit 48 includes a sensor set 50-1 for sensing parameters in the sample chamber 44 of apparatus 24-1 (as is schematically illustrated by dotted line 52-1), a sensor set 50-2 for sensing parameters in the sample chamber (not illustrated) of experimental apparatus 24-2 (as is schematically indicated by dotted line 52-2), and so forth, until an n-th sensor set 50-n that senses conditions in the sample chamber (not illustrated) of experimental apparatus 24-n (as is schematically illustrated by dotted line 52-n).

Each sensor set preferably includes an optical sensor, such as a television camera, charge-coupled device, or other image sensor that generates an image signal indicative of a sample that is undergoing modification as a result of the reagent. The nature of the sample will be discussed in more detail later but, for present purposes, it is appropriate to note that the sample may be a growing protein crystal. The optical sensor, however, is not limited to sensors that generate image signals. The optical signal may, for example, comprise a light source that emits light into the sample chamber and a light detector that detects one or more features of the light that has travelled through the sample chamber, such as how much of this light is absorbed, occluded, refracted, or scattered by the sample. The sensor sets may also include temperature sensors, pH sensors, chemical probes, and sensors for other parameters of interest. However, it should be understood that the set of sensors within a sensor set can, within the scope of the present invention, consist of only a single sensor (that is, a set with one member).

With continuing reference to FIG. 1, electrical signals generated by the sensor sets 50-1 to 50-n are provided to an analysis system 54. The analysis conducted by system 54 will be described later. An input/output unit 56 (which may be a computer with a keyboard and a monitor) communicates with the analysis system 54. The analysis system 54 is operably linked to a control system 58. The analysis system may comprise a computer program that resides in the same device as the control system, or it may be linked to the control system by way of a bus 60. The control system 58 responds to signals received from analysis system 54 by generating electrical control signals that are supplied to the pumps 30 and the temperature controllers 38 of the experimental apparatuses 24-1 to 24-n.

Apparatus 20 may be employed for conducting a number n of experiments in parallel, with one or more parameters being varied in each experiment, and for dynamically changing the parameters in the various units as the experiments progress in accordance with predetermined criteria relating to the state of the sample in each unit. For example, in crystallizing proteins, the controlling criteria typically relate to the detection of crystal nuclei in the sample chambers. In cell assays, the controlling criteria may relate to the growth pattern, state of differentiation, metabolism, or physiology, of the cells in each dialysis unit. The analysis system 54 receives sensor signals from the sensor sets 50-1 to 50-n, interprets the results obtained by the apparatuses 24-1 to 24-n over a time interval, determines which samples, if any, satisfy predetermined criteria for triggering a response, and transmits this information to the control system 58. The control system 58 then sets the parameter or parameters that are to be employed during the next time interval. As a practical matter, it is convenient to vary only one parameter as time progresses, keeping all other parameters constant.

The user of the system defines the predetermined criteria relating to the states of the samples, and the manner by which the parameters in the various units are dynamically to be changed in accordance with the predetermined criteria. For example, in crystallization, the user determines the type of precipitant and the concentration of precipitant in the precipitant solution added to each unit, the volume of precipitant solution added per time interval, and the rate at which the precipitant solution is added during the interval. A predetermined criterion is usually nucleation of a crystal, and the control system may be programmed to cease adding precipitant to those samples in which nucleation is detected. The process may periodically transfer an equal volume of precipitant solution of a constant concentration to each crystallization unit. Alternatively, equal or varying volumes of precipitant solutions of different concentrations may added to different units at the same or different rates.

Table 1 illustrates an example in which the temperature parameter is kept constant in all of the experimental apparatuses 24-1 to 24-n, each reagent chamber 40 contains the same protein, and different precipitants (or combinations or concentrations of precipitants) are held in the reagent reservoirs 28 of each of the experimental apparatuses, the same volume of precipitant solution, 5 microliters, is added to each of the reagent chambers 40 at the same rate within each time period, and the sensor sets are charge-coupled devices that generate image signals of protein crystals growing in the sample chambers 44. The physical sizes of the crystals are determined from the image signals. The task assigned to the apparatus 20 in this example is to find the concentration of precipitant at which crystal nucleation occurs for each different type of protein. In this example, monitoring of the samples by the sensor continues even after nucleation is detected; however, those skilled in the art would appreciate that such monitoring is optional.

TABLE 1

| | Volume | Nucleation | Volume | Nucleation | Volume | Nucleation | Volume |
|---|---|---|---|---|---|---|---|
| Experimental | Added at | Detected | Added at | Detected | Added at | Detected | Added at |
| Apparatus | Time tₙ | at Time t_{n + 1} | Time t_{n + 1} | at Time t_{n + 2} | Time t_{n + 2} | at Time t_{n + 3} | Time t_{n + 3} |
| Number one | 5λ | no | 5λ | no | 5λ | No | 5λ |
| Number two | 5λ | no | 5λ | no | 5λ | No | 5λ |
| Number three | 5λ | yes | 0 | yes | 0 | Yes | 0 |
| Number four | 5λ | no | 5λ | no | 5λ | No | 5λ |
| Number five | 5λ | no | 5λ | no | 5λ | Yes | 0 |

In Table 1, an equivalent volume of precipitant is added to each unit at a time tₙ. At time tₙ₊₁, the samples are examined to determine if nucleation can be detected. In the example, nucleation is detected in sample number three. The controller then directs the fluid transfer mechanism(s) to add an additional aliquot of precipitant to the reagent chambers of units one, two, four, and five, but not unit number three. After time period tₙ₊2 has lapsed, the samples are again examined to detect nucleation. In the example, nucleation is again detected only in sample number three, so at time period tₙ₊₂ an additional aliquot of precipitant is added to the reagent chambers of units one, two, four, and five. At time period tₙ₊₃, the samples are again examined and nucleation is detected in sample number five as well as in sample number three. Accordingly, at time period tₙ₊₃ an additional aliquot of precipitant is added to the reagent chambers of units one, two, and four, but not to units three and five. The process of periodically monitoring for nucleation, and adding additional precipitant to the samples in which nucleation has not occurred, proceeds until the system is automatically stopped, e.g., because the reagent reservoirs are depleted, or because the user has programmed the controller to stop the process at a particular time.

Crystallization typically progresses beyond nucleation after reagent flow is stopped, for a long time. For example, crystal growth may proceed for about a day, whereas the cycle time for adding new reagent would be about one hour. If crystal growth stops, then the flow can be automatically restarted to restart growth. Also, if desired, crystals can be dissolved in part by reversing reagent flow.

In many systems, the samples may show a wide range of responses, and there it is desired to determine the dynamic solution parameters that provide the “best” outcome at different points in time. For example, cells may show a varying, non-linear response to the rate at which the concentration of a growth-regulating factor is changed. In such an embodiment, the analysis system 54 receives sensor signals from the sensor sets 50-1 to 50-n, ranks the results obtained by the apparatuses 24-1 to 24-n over a time interval, and identifies this ranking to the control system 58. The control system 58 then sets the parameter or parameters that are to be employed during the next time interval. The parameter or parameters that are to be employed by the apparatuses 24-1 to 24-n are reset so as to cluster about the parameter or parameters that were used in the experimental apparatus that had the best result during the time interval just passed.

Table 2 illustrates an example in which the temperature parameter is kept constant in all of the experimental apparatuses 24-1 to 24-n, the same reagent at the same concentration is held in the reagent reservoirs 28 of all of the experimental apparatuses, the parameter that is varied is the flow rate of the reagent into the reagent chambers 40, and the sensor sets are charge-coupled devices that generate image signals of cultured cell samples in the sample chambers 44. The reagent provided to the cells is a growth-promoting factor, and the rates of cell division are determined from the image signals. The task assigned to the apparatus 20 in this example is to find the best sequence of flow rates for growing the cells most rapidly.

TABLE 2

| | | | | Rate of | | Rate of | |
|---|---|---|---|---|---|---|---|
| | Initial | Rate of Cell | New | Cell | New | Cell | New |
| Experimental | Flow | Division | Flow | Division | Flow | Division | Flow |
| Apparatus | Rate | at t₁ | Rate | at t₂ | Rate | at t₃ | Rate |
| number one | a | Second-best | b − 2δ | worst | B + δ − 3ε | | |
| number two | b | best | b − δ | Fourth-best | B + δ − 2ε | Et | Cetera |
| number three | c | third-best | B | third-best | B + δ − ε | | |
| number four | d | Fourth-best | b + δ | best | b + δ | | |
| number five | e | worst | b + 2δ | Second- | B + δ − ε | | |
| | | | | best | | | |

In Table 2, an initial flow rate of reagent is set for each of five experimental apparatuses. At a time t₁, at the end of an initial time period (of one hour, for example), the sensor signals are analyzed to determine which experimental apparatus produced the highest cell growth rate. In the example shown in Table 2, the best result during the initial time interval was obtained with the flow rate b that was employed in the experimental apparatus number two. The flow rate b then becomes a starting point for the next time interval. The flow rates a and c were second and third best, and an adjustment value δ is selected such that four times δ approximately spans the difference between flow rate a and c. New flow rates for the second time interval thus become b, b±δ, and ±2δ. At a time t₂ at the end of the second time interval (another hour, for example), the best and worst results are determined again, and a further correction value ε is used to find a new flow rate for the next interval. This process of setting parameters, measuring the outcome at the end of a time interval, ranking the outcomes, and using the rankings to determine parameter values that are to be used in the next time interval, continues for subsequent time interval (the “Et Cetera” in Table 2).

The construction of apparatus 20 permits the first time interval to start and stop at approximately the same time for all of the experimental apparatuses 24-1 to 24-n, the second time interval to start and stop at approximately the same time for all of the experimental apparatuses, and so on for subsequent time intervals. However, it is possible to stagger the start and stop times so long as the duration of a given time interval is the same or approximately the same for all of the experimental apparatuses. For example, it is possible for the start time for the first time interval for experimental apparatus 24-2 during a time interval to be a few minutes later than the start time for experimental apparatuses 24-1 during that time interval, so long as the stop time for experimental apparatus 24-2 is also delayed (and, of course, the same for the other experimental apparatuses). Furthermore, although it is convenient for the time intervals to have approximately equal durations, it is also possible to employ different durations for different time intervals. For example, one hour may be selected as the duration for the first three time intervals and half an hour for subsequent time intervals.

The analysis system 54 stores the results of the experiments and the modifications in parameter values. The parameter values that lead to the best results as a function of time can therefore be determined from the experimental results captured by the analysis system 54, and can be displayed or printed by I/O unit 56. The I/O unit 56 can also be used by a technician to monitor the parallel experiments while they are in progress, and the technician can manually adjust the parameter values from time to time, if appropriate.

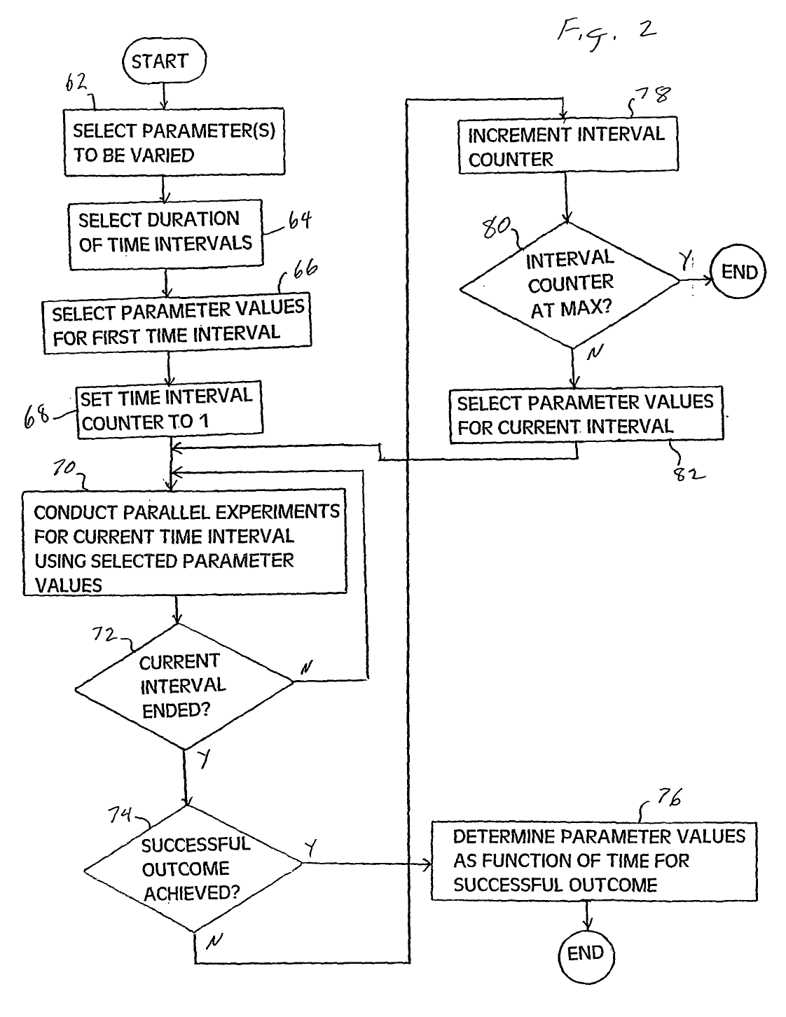

The operation of apparatus 20 will now be further explained with reference to the flow chart shown in FIG. 2. In FIG. 2, the parameter or parameters that are to be varied (reagent flow rate, temperature, etc.) are selected in a step 62. The durations of the time intervals are selected in a step 64. It is convenient for the time intervals to have equal durations but, as was noted above, this is not essential and it may be desirable to select time intervals that are smaller than usual during periods where uncertainties exist in the phenomenon under observation Parameter values for the first time interval are selected in a step 66, and a time interval counter is set to 1 in a step 68.

In a step 70, n experiments are conducted in parallel by the experimental apparatuses 24-1 to 24-n. A check is made at step 72 to determine whether the current interval has ended. The current interval, during the first repetition of the process shown in FIG. 2, is the first interval that was set at step 68. If the current interval has not ended (“N” at step 72), the process reverts to step 70 for continuing the parallel experiments that are in progress.

If the current interval has ended (“Y” at step 72), a check is conducted at step 74 to determine whether any of the experimental apparatuses 24-1 to 24-n has achieved a result that is equal to or exceeds predetermined criteria for a successful outcome. What these predetermined criteria might be depends upon the nature of the experiments. For example, if the experiments are being conducted in order to determine an optimum way for rapidly growing crystals of a particular protein, the final crystal size that is desired might represent the successful outcome. If the successful outcome has been achieved (“Y” at step 74), the parameter values for a successful outcome as a function of time are determined and sent to I/O unit 56 in step 76, and the process ends. If the successful outcome has not been achieved (“N” at step 74), the interval counter is incremented in step 78. In the second repetition of the process, the interval counter would indicate the second time interval, in the third repetition, it would indicate the third time interval, and so on for subsequent intervals. In the event that the apparatus 20 is left unattended for long periods of time, it is desirable to stop the apparatus if a successful outcome has not been achieved during a suitably large number of time intervals, perhaps due to a malfunction in apparatus 20, depletion of the fluid reagent, and so forth. This is the reason for step 80, which checks whether the number of the time interval has reached a predetermined maximum value and stops the process (“Y” at step 80) if it has. Otherwise (“N” at step 80), new parameter values are selected in step 82 for the time interval currently designated by the interval counter, and the process proceeds to step 70 for conducting parallel experiments for the time interval designated by the interval counter using the parameter value selected at step 82.

“X-Y” Table. Embodiment

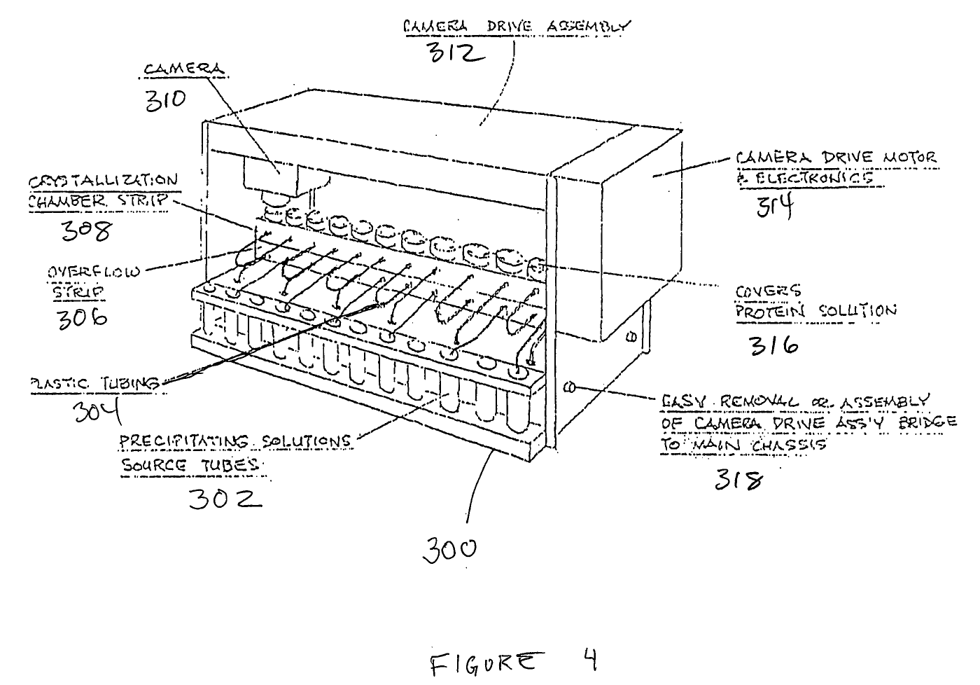

An “x-y” table embodiment is shown in FIGS. 4-7.

Structure.

FIGS. 4-5 show chassis 300, precipitating solution source tubes 302, plastic tubing 304, overflow strip 306, crystallization strip 308, camera 310 mounted on camera guide rail and drive assembly 312, and controlled by camera drive motor and electronics 314. The camera drive assembly is easily removed by fasteners 318 for loading and cleaning. The sample chambers 314 are configured as covers containing protein, presenting a clear window to the camera, and separated by membranes from the individual reagent chambers 309 mounted on the reagent chamber strip 308. As shown in FIG. 5, micropumps 320, terminal strips 322, and wiring/control harness 324 are mounted within the chassis beneath the support for the crystallization units

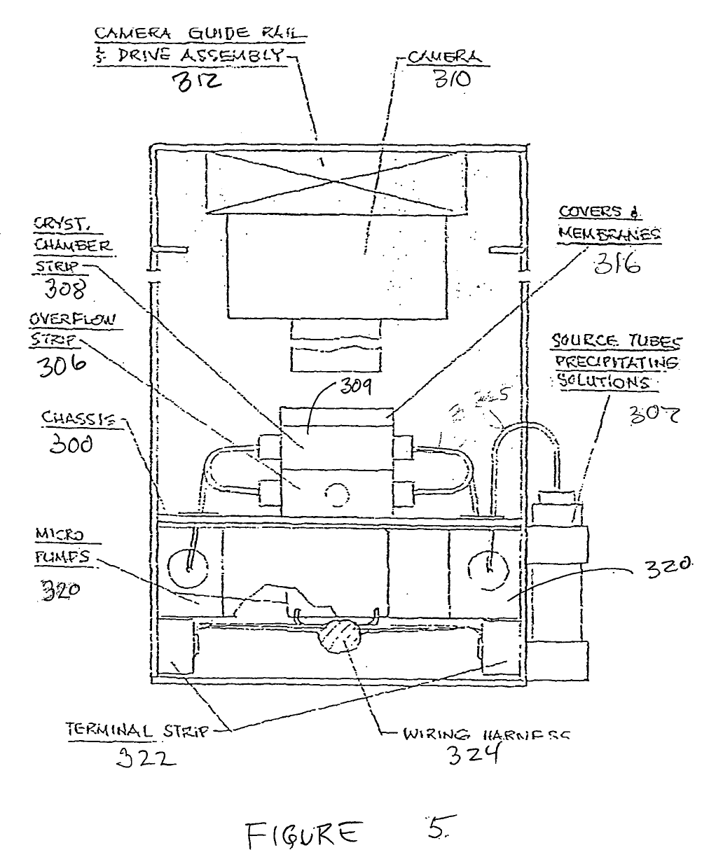

FIG. 6 schematically depicts a 12 crystallization chamber strip. In FIG. 6, each reaction chamber 326 of strip 308 has an inlet 327 connected via tubing 328 to micropump 329 and supply reservoir 330, and also has a drain 332.

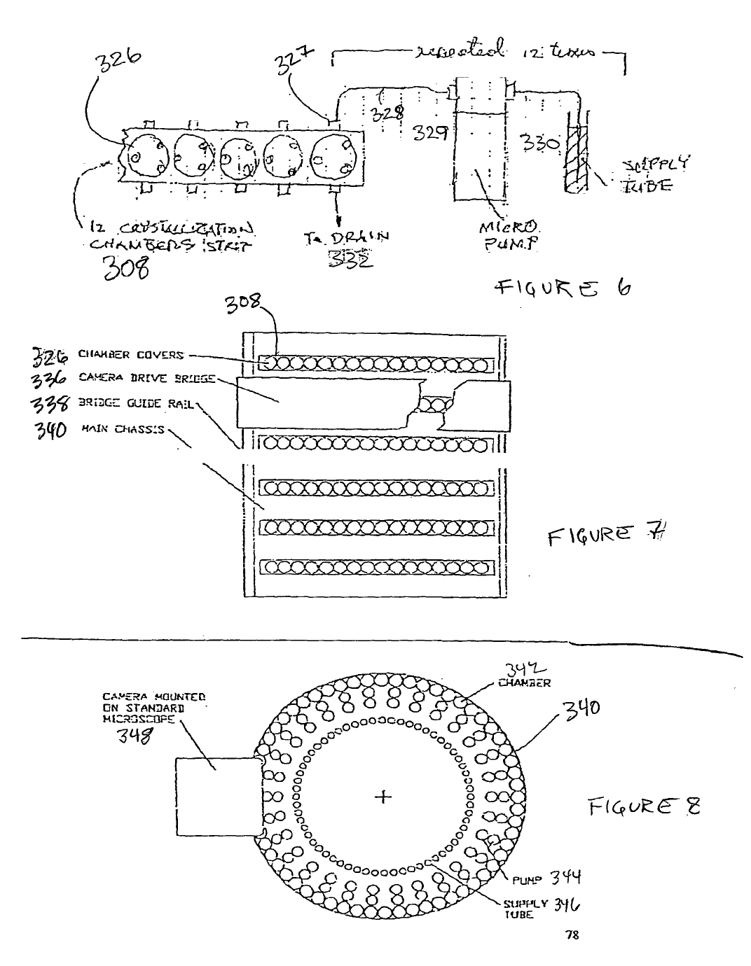

FIG. 7 is a top view of an x-y table embodiment of the invention having several rows of reaction chambers. FIG. 7 shows reaction chamber strips 308, with the covers of each reaction chamber 326, camera drive bridge 336, bridge guide rail 338, and main chassis 340. Six rows of 16 chambers are shown. Micropumps, supply reservoirs, and interconnections are omitted for simplicity.

The arrangement shown in FIGS. 4 and 5 has all of the chemical components (crystallization chamber, pumps, supply tubes) mounted onto a stationary chassis with a camera driven by a stepper motor, moving from chamber to chamber. The features include the following:

1—A plastic strip containing 12 wells (crystallization chambers) is used.

2—12 covers, shown as individual covers, but may be combined into one strip-using a strip of membrane to reduce the handling requirements.

3—The above sits on another plastic strip which acts as the drain. As precipitating solution is pumped into any well, an equal volume is forced out as overflow and into the drain.

4—micro-pumps (1″ diameter×2.5″ long) are mounted on the underside of the chassis (FIG. 6).

5—There are 12 supply tubes mounted to the outside of the chassis.

6—A bridge is mounted to the chassis-it includes a rail and carriage holding the microscope camera-and the motor which drives the carriage along the rail. The entire assembly can be easily removed for loading of the equipment and easy access to all components.

Operation:

The strip of 12 chambers and covers can be loaded off the chassis—for convenience. Both cleaning and loading (and unloading) can be done off the equipment while another experiment is running with another strip. Removing the strip requires disconnecting all of the tubes to the pump and to the drain, using quick-disconnect tube connectors to make it easy.

A one-row one-camera axis system can easily be expanded to a multi-row system with 2 axes for the camera to travel on and more mechanization of operations (FIG. 7). This system can be packaged in many configurations including having the microscope-camera stationary and moving the crystallization chambers. In this configuration the x-y table motion is properly damped.

Aspects of the invention include a digital monitoring system, interfaced with a computer to store the images for remote viewing, exchanging the stepper motors with micro-pumps capable of pumping volumes as little as 4 microliters, expansion of the system to 100 chambers such that 100 independent conditions can be screened at once, compatibility with the existing commercial screens, and improved membrane assembly procedure that can be done rapidly and consistently.

Carousel System

A carousel system can be employed having a stationary array of dialysis units above which a camera-microscope would rotate; however, in the system described below, a rotatable disk is used to successively move each dialysis unit into position to be monitored by a fixed microscope-camera unit. The disk may also be mounted vertically to permit horizontal sensing e.g. with light scattering.

Although this device has been developed for the production of crystals, it is equally adept at controlling the flow of nutrient medium and reagents required to support the survival and growth of cells within dialysis units adapted for cell culture, permitting control over cell growth and other cellular processes.

Structure.

The sample chambers of one hundred dynamic dialysis units whose dimensions have been optimized for protein crystallography are filled with 1-3 microliters of protein solution (or less). Precipitant solutions are fed into the reagent chambers, each of which has a volume of about 65 microliters. Of course, alternative embodiments could use sample and reagent chambers having different dimensions; for example, the sample chamber could be hav a volume of from 1-100 or more microliters, preferably from 1-10 microliters, and the reagent chamber could have a volume of from about 20 microliters to 10 milliliters, preferably from 50-100 microliters, for protein crystallization. The device described by this application increases the concentration of precipitant solution in the upper chamber (reagent solution). By the process of osmosis through a semi-permeable membrane, the concentration of reagent solution in the sample chamber is increased until the optimum conditions are attained for production of the highest quality crystal. At that point the device holds the solution at that concentration.

Set-Up of the Carousel Crystallization System.

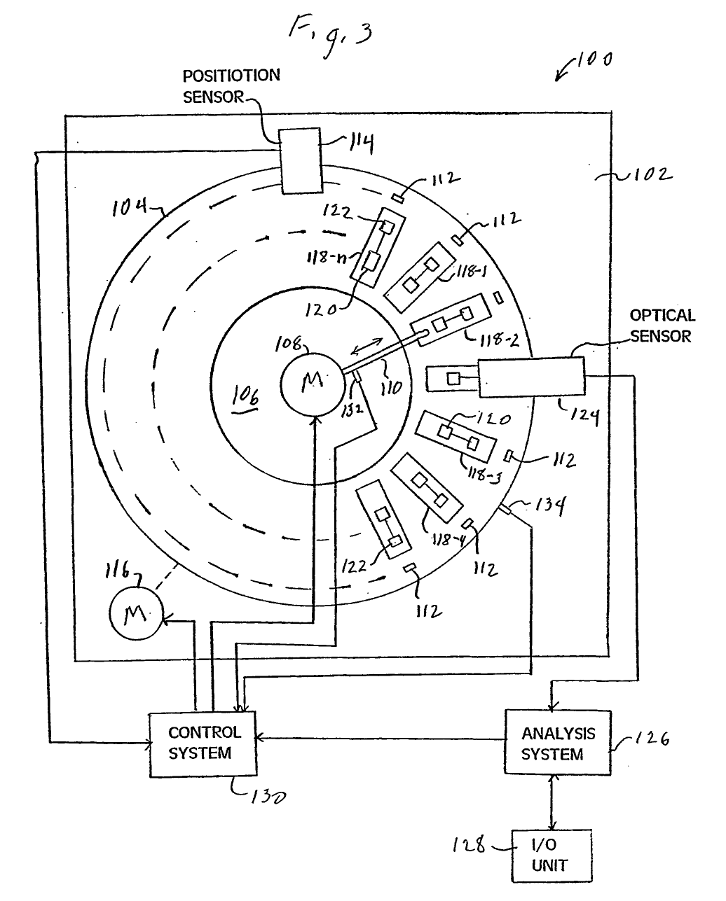

An embodiment of the carousel system is schematically shown in FIG. 3. One hundred dialysis assemblies 118-1 to 118-n are attached to the surface of the rotating plate 104. Each dialysis assembly includes a dynamic dialysis unit 122 that is positioned near the periphery of rotating plate 104, and a reservoir assembly 120 that comprises a reagent reservoir and a fluid transfer mechanism. The reagent reservoirs are charged with the appropriate precipitant solution for each sample. The reservoir assembles are connected to the dialysis units with plastic tubing.

Operation:

Using known proteins and crystallization concentration times (≈36 hours) crystallization is started under a microscope. When crystallization is first detected, the pumping is stopped and the crystallization growth is monitored. Crystals may also be grown by other methods and their size and quality compared. The tests are repeated with the same protein (to determine repeatability) and with other proteins whose crystallization conditions are known. In some cases, proteins are crystallized, but the size or quality is not good enough to collect diffraction data. Using the same screens, the present invention can be used to improve the size of the crystals, thus yielding better diffraction data.

The operation is computer controlled. At the start of each processing run the operator sets the desired parameters for each of the one hundred chambers. When the process is started the rotation drive motor 116 indexes rotating plate 104 to the first dialysis unit 122 and stops. Motor 108 extends actuation shaft 110 until it contacts the reservoir assembly 120. Motor 108 stops and then precisely dispenses the desired amount of solution, at the desired rate into the dynamic dialysis unit 122. Fluid leaving dynamic dialysis unit 122 is sent to the recovery side of the reservoir assembly in such a way that there are no pressure differentials are created within the dialysis unit. Actuation shaft 110 then withdraws to its original position. The rotation plate then indexes to the next chamber position and the sequence is repeated.

Process Control:

The process is automatically controlled, based on the signals received from an optical digital optical microscope and /or a laser light scattering instrument. When optimal conditions are achieved with in each crystallization chamber the control program marks that chamber station. Rotation drive motor 116 will no longer stop the rotation of disk 104 at that station, and actuator motor 108 will not operate until the next desired station is reached.

When all of the dynamic dialysis units 122 have achieved the desired process completion the entire rotating disk 104 with attached dialysis assemblies 118-1 to 118-n is removed. Another, previously prepared disk 104 with more dialysis assemblies can then be placed on the base plate 102.

Details of Carousel System (Automatic Robotic Device):

FIG. 3 illustrates an apparatus for independently and dynamically controlling reagent-induced transformations. The apparatus 100 includes a chassis 102, and a turntable 104 is rotatably mounted on the chassis 102. The turntable 104 has a central aperture 106. A motor 108 is mounted on chassis 102 within the central aperture 106. The motor 108 extends or retracts an actuation shaft 110, which is mounted for linear movement in a plane which extends slightly above the upper surface of turntable 104. The motor 108 may be a linear motor, and the shaft 110 may be the shaft of this linear motor, or the motor 108 may be a rotary motor that is linked by gearing (not illustrated) to the shaft 110.

Near the outer periphery of turntable 104 is a ring of openings 112. A position sensor 114 is mounted on chassis 102 in order to detect the openings 112, and thereby determine when the turntable 104 is in a sequence of predetermined positions. The turntable is rotated by a motor 116 via a gearing arrangement (not illustrated).

Dialysis assemblies 118-1 to 118-n are mounted in a ring on the upper surface of turntable 104. Each of these experimental apparatuses includes a fluid transfer mechanism 120 that is hydraulically linked to a dynamic dialysis unit 122. The fluid transfer mechanisms 120 of the apparatuses 118-1 to 118-n are oriented toward the central aperture 106 of turntable 104, and the dynamic dialysis units 122 are oriented toward the periphery of the turntable 104. Each dialysis unit has a transparent window (not shown) through which the interior of the sample chamber can be viewed. An optical sensor 124, such as a television camera coupled to a microscope arrangement (not shown), is mounted on the chassis 102 at a position such that the contents of the dynamic dialysis units 122 can be sensed.

Image signals from the optical sensor are supplied to an analysis system 126 which is connected to an input/output unit 128. The I/O unit 128 may be a computer having a monitor and keyboard (not illustrated). The analysis unit 126 is also connected to a control system 130. In addition to signals from analysis system 126, the control system 130 receives position signals from the sensor 114 and signals that indicate when the shaft 110 is in physical contact with any of the fluid transfer mechanisms 120.

The fluid transfer mechanisms 120 may be plunger-type syringes (not illustrated in FIG. 3) that are loaded with reagent fluid. Such syringes thus serve as both reagent reservoirs and mechanically-operated pumps, which transmit reagent to the associated dynamic analysis units 122 in response to pressure on plungers (not illustrated) of the syringes. As for the dynamic analysis units 122 themselves, they include reagent chambers and sample chambers that are separated by a semi-permeable membrane. Further details of experimental apparatuses that employ syringes as fluid transfer mechanisms can be found in U.S. Pat. No. 5,961,934, and in International Publication No. WO 99/42191, the disclosures of which are incorporated herein by reference.

As was previously noted, the control system 130 receives signals indicating when the actuation shaft 110 is in physical contact with a fluid transfer mechanism 120 (that is, in physical contact with a hypodermic plunger). How such signals can be generated will now be addressed.

A brush 132 is mounted on chassis 132 at a position to contact shaft 110, which is made of metal. Another brush, 134, is mounted on the chassis 102 at a position to contact the turntable 108, which is also made of metal. Metal films (not illustrated) attached to the plungers (not illustrated) of the syringes (not illustrated) used for the fluid transfer mechanisms 120 are electrically connected to the turntable 104 and thus, via the brush 134, to the control system 130. The control system 130 maintains the brushes 132 and 134 at different electrical potentials except when the actuation shaft 110 contacts one of the metal films. The potential difference between the brushes drops to zero during contact with a metal film, though, and this provides a signal indicating whether or not the shaft 110 is in contact with a plunger.

In contrast to the apparatus 20 shown in FIG. 1, which employed electrically operated pumps 30, the pumping function performed by the syringes of fluid transfer mechanisms 120 depends upon mechanical force exerted on the plungers. That is, while each pump 30 in apparatus 20 had its own motor, a single motor (108) is used to actuate all of the fluid transfer mechanisms 120 in apparatus 100. Furthermore, the sensor unit 48 in apparatus 20 had sensor sets dedicated to each dynamic analysis unit 36, but a single sensor set (sensor 124, a set having one member) in apparatus 100 senses all of the dynamic analysis units 122 that pass under it.

During a time interval, motor 108 drives actuation shaft 110 to provide different flow rates of reagent in the different experimental apparatuses 118-1 to 118-n, and the optical sensor 124 reads the result for each of the dynamic analysis units 122. Based upon the results, the analysis system 126 ranks the results during a given time interval and parameter values are selected for use during the next time interval, along the lines previously discussed.

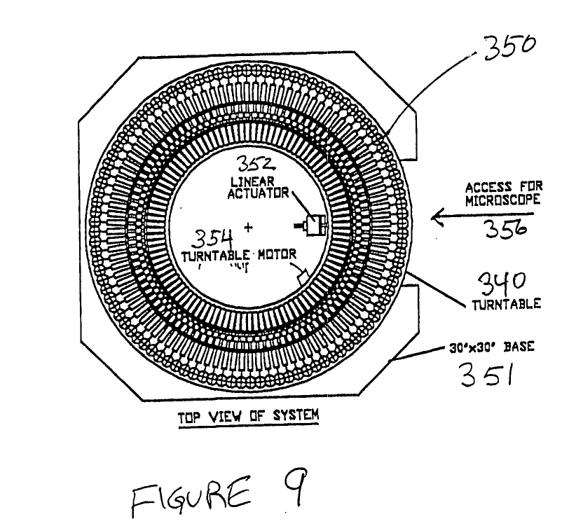

Carousel embodiments are shown in FIGS. 8-12. As shown the camera and microscope are stationary and the crystallization chambers, micropumps, and chemical elements are rotated. The carousel oscillates through an angle less than 360° to avoid the use of slip rings for the solenoids.

FIG. 8 is a top view of a carousel embodiment of the invention. FIG. 8 shows carousel plate 340 on which are mounted up to 60, 100, or more reaction chambers 342, with pumps 344, and supply tubes 346 from a reservoir (not shown). Camera 348 is mounted on a standard microscope.

FIGS. 9-12 illustrate further aspects of carousel embodiments of an automated robotic device for dynamically controlled crystallization of proteins in accordance with the invention.

In FIG. 9, turntable 340 is mounted on base 351, and driven by motor 354. Around the circumference, oriented radially, are 100 syringe/reservoir assemblies (dynamic dialysis units) 350, which may be positioned at a linear actuator 352. Access for a microscope (not shown) is provided at 356.

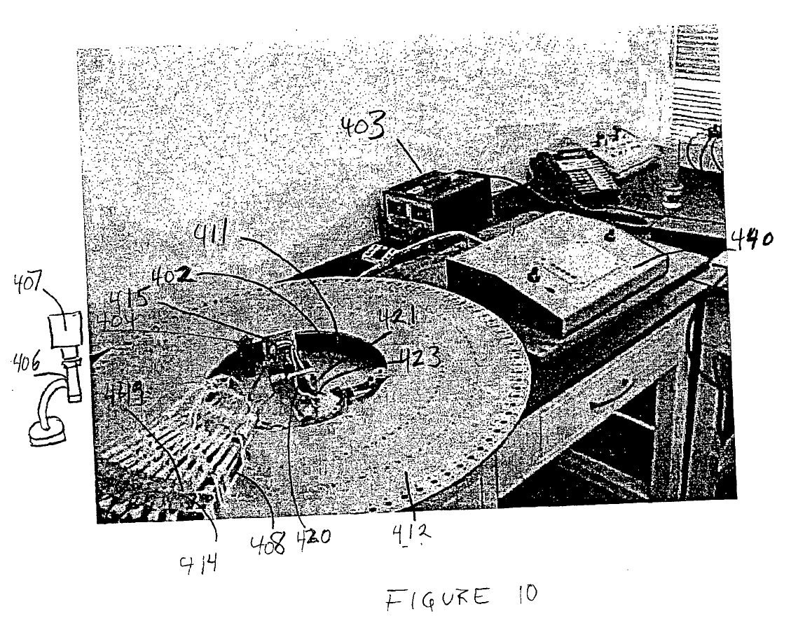

A further embodiment of an Automatic Robotic Device is illustrated in FIG. 10. Apparatus 410 includes rotatable support disk 412, in the center of which is an opening 411, and on the surface of which is attached multiple dialysis assemblies 408, in a radial orientation. Support disk 412 is rotatably supported on rigid base 402. Motor 415 is operably coupled to support disk 412, so that motor 415 rotates disk 412 when it is activated. Position sensor 404 is coupled to and senses the position of support disk 412 and thereby identifies the location of addressable dialysis assemblies 408. Camera 407 is mounted on microscope 406, which is positioned relative to support disk 412 as to be able to view through transparent window 449 of dynamic dialysis unit 414 of a dialysis assembly 408.

Motor 420 is fixed to base 402 within the central opening 411, and is operably coupled to threaded push rod 421. Push rod 421 is insulated from support disk 412. Voltage source 403 is connected to, and creates an electric potential difference between, push rod 421 and support disk 412. Switch 423 is attached to push rod 421, and is operably connected to motor 420 and to controller 440. Controller 440 is operably coupled to motor 415, position sensor 404, voltage detector 405, motor 420, and camera 407.

When motor 420 is activated by controller 440, it engages and causes push rod 421 to move forward until it contacts slide rod 426 of the dialysis assembly 408 which is positioned in line before it. Contact between push rod 421 and slide rod 426 activates switch 423, which sends a signal to motor 420 to halt movement of push rod 421, and to controller 440 that push rod 421 has made contact with slide rod 426. Controller 440 then activates motor 420 to move push rod 421 forward for a predetermined distance. This in turn pushes slide rod 426 forward, resulting in transfer of reagent solution into dialysis unit 408.

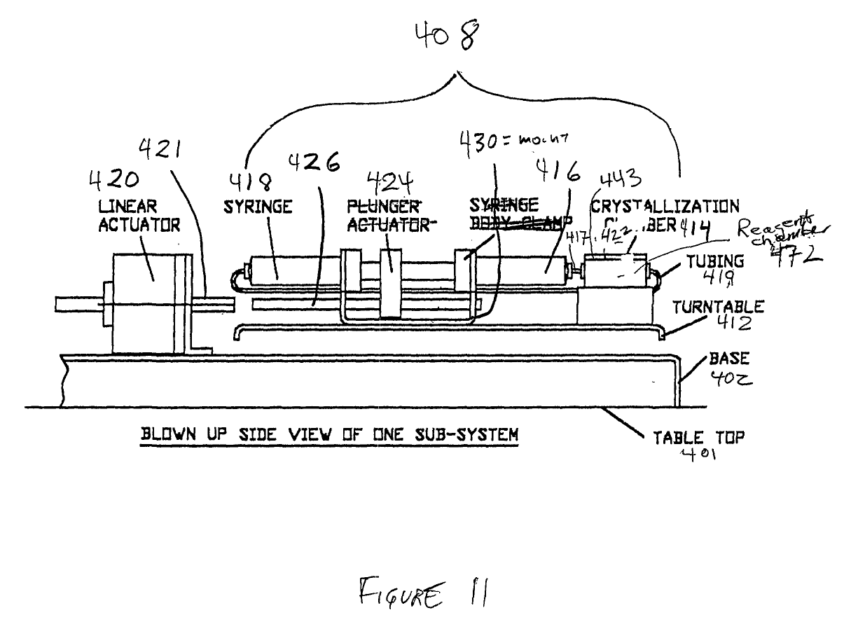

FIG. 11 is a side view of the reservoir subsystem 408 of the second carousel embodiment, and illustrates motor 420, with push rod 421 in alignment to engage slide rod 426 of dialysis assembly 408. Dialysis assembly 408 comprises a dynamic dialysis unit 414 that is attached near to the outer edge of support disk 412, a first syringe 416 and a second syringe 418 that are supported by syringe mount 430 so as to point in opposite directions with their positions relative to each other being fixed, and a clamp 424 that interlocks the ends of the syringe plungers together. Syringe mount 430 is fixed to support disk 412 so that the paired reagent syringes are radially oriented on disk 412, with the fluid-transferring end of first syringe 416 being positioned proximate to the dynamic dialysis unit to which it is attached, and the fluid-transferring end of second syringe 418 being pointing toward the center of disk 412. Syringe 416 is coupled to dynamic dialysis unit 414 by tube 417 serving as a conduit. Syringe 418 is coupled to dynamic dialysis unit 414 by tube 419 serving as a conduit. Syringes 416 and 418 serve as reagent solution reservoirs, as described below.

In FIG. 11, slide rod 426 is supported beneath syringes 416 and 418 by two bronze bushings contained within syringe mount 430, and is disposed to slide in a direction parallel to the long axis of syringes 416 and 418. Slide rod 426 is coupled to plunger clamp 424, so that as slide rod 426 slides in a direction away from the center of the disk, the plunger of syringe 416 is depressed, and the plunger of syringe 418 is retracted. This results in the transfer of a volume of reagent solution from syringe 416 from conduit tubing 417 into dynamic dialysis unit 414, and the transfer of an equal volume of solution from dynamic dialysis unit 414 into conduit tubing 417.

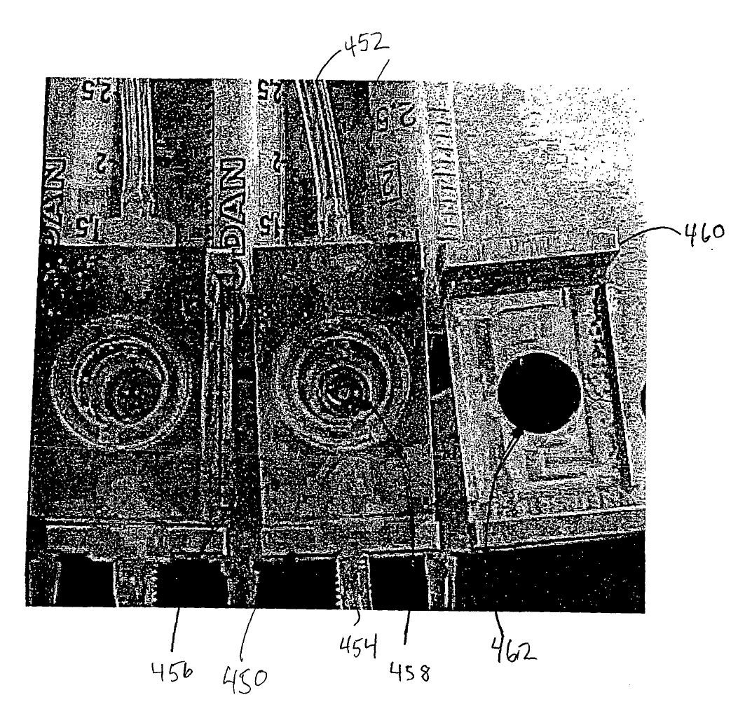

FIG. 12 is a top view of a reaction unit (sample chamber/reagent chamber) subassembly, mounted in a carousel embodiment of the invention. In FIG. 12, reaction units 450 are shown, each having reagent inlet tube 452 and drain tube 454 connected to the reagent chamber visible through opening 462, in reaction unit chassis 460, where the sample chamber 456 has been removed. A dialysis membrane (not shown) is mounted in opening 462 on the lower portion of the sample chamber 456. The top of sample chamber 456 includes a window 458 for sensing the condition of the sample.

FIG. 13 is a side view of a reaction unit (sample chamber/reagent chamber) subassembly, dismounted. In FIG. 13, reaction unit 450 is shown, having reagent inlet fitting 464 and drain fitting 466 connected to the reagent chamber 472. Opening 462 in reaction unit chassis 460 is shaped to receive sample chamber cover 456 which has a protuberant sample chamber 478, covered with a dialysis membrane and able to be mounted in opening 462 on the lower portion of the sample chamber 456. The mounting of cover 456 is accomplished with special tool 474, which grips fittings 476, and permits the cover to be placed on the lower portion and twisted to lock under flanges 480. Reagent chamber 472 has bored channels to the inlet and drain fittings, and at its base has threaded portion 470 to receive base cap 468. In the modification of the reaction unit for cell growth, drain 466 is closed and cover 456 is modified to have a drain, so that fluid flows into the reagent chamber, through the membrane, and out through the cover.

Preparation.

One hundred crystal chamber assemblies 414, whose dimensions have been optimized, are charged with very small amounts of rare protein solution in the upper chamber 422 (FIG. 11). Reagent solutions are fed into the reagent chamber 472. The device described by this application increases the concentration of reagent in the solution in the reagent chamber 472. The process of osmosis through a semi-permeable membrane 443 increases concentration of solution the sample chamber 422 until the optimum conditions are attained for production of the highest quality crystal. At that point the device holds the solution at that concentration.

The device described in this application achieves the desired results by the following process. For each dynamic dialysis unit 408, the sample chamber 414 is charged with protein solution, and the reagent chamber 472 is charged with salt solution. One hundred of these dynamic dialysis units 414 are attached to the outer rim of the rotating plate 12.

One hundred first syringes 416 are charged with the appropriate salt solution for each chamber, and syringes 416 and 418 are mounted on syringe mounts 430 that in turn are fixed to rotating support disk 412 as shown in FIGS. 10 and 11. Syringes 416 and 418 are connected to the reagent chamber 472 of each dynamic dialysis unit 414 with plastic tubing 17 and 19, respectively. The operation is computer controlled. At the start of each processing run the operator sets the desired parameters for each of the one hundred chambers.

Operating Sequence.

When the process is started the rotation drive motor 415 indexes rotating disk 412 to the first dialysis unit and stops. Linear actuator motor 420 moves threaded push rod 421 until it contacts slide rod 426 of the dialysis assembly 408. Motor 420 stops and then precisely dispenses the desired amount of solution, at the desired rate, from conduit tubing 417 into reagent chamber 445. Fluid forced from reagent chamber 445 is sent via conduit tubing 419 to the recovery syringe 418. in such a way that no pressure differentials are created within the dynamic dialysis chamber and the connecting tubing. Linear actuator motor 420 then withdraws push rod 421 to its original position. Motor 415 then rotates disk 412 to the next dynamic dialysis unit 414, and the sequence is repeated.

Process Control.

The process is automatically controlled, based on the signals received from digital optical microscope 406, and /or a laser light scattering. When optimal conditions are achieved with in each crystallization chamber the control program marks that chamber station. Rotation drive motor 415 will no longer stop the rotation of disk 412 at that station, and linear actuator motor 420 will not operate until the next desired station is reached. When sample chambers 442 in all of the dynamic dialysis units 414 have achieved the desired process completion the entire rotating disk 412 with attached dialysis assemblies 408 is removed. Another, previously prepared disk 412 with more dialysis assemblies 408 can then be placed on the base plate 2.

### Example of Operation of the Carousel System

The system is operated essentially as described above. For example, the reagent reservoirs are filled with the desired precipitant solutions. 2-3 microliters of protein solution are placed in the sample chamber, and about 65 microliters of reagent solution are placed in the reagent chamber, of each dialysis unit, with the solutions in the sample and reagent solutions contacting and being separated by a semipermeable membrane. The controller is programmed to pump 2-5 microliters of precipitant into the reagent chamber of each unit every 1.5-2 hours. Digital images of the magnified interior of each sample chamber are periodically obtained with the microscope-camera. and pixel-by-pixel comparison of the optical density of each image to a previous image permits detection of crystal nuclei as the become large enough to be sensed by the camera. Upon detection of crystal nuclei in a dialysis unit, the controller automatically directs the system to halt the further addition of precipitant to that unit. Crystals are frequently observed within 3 days of operation of the system. The invention has been used successfully to crystallize “orphan” proteins—proteins of unknown function.

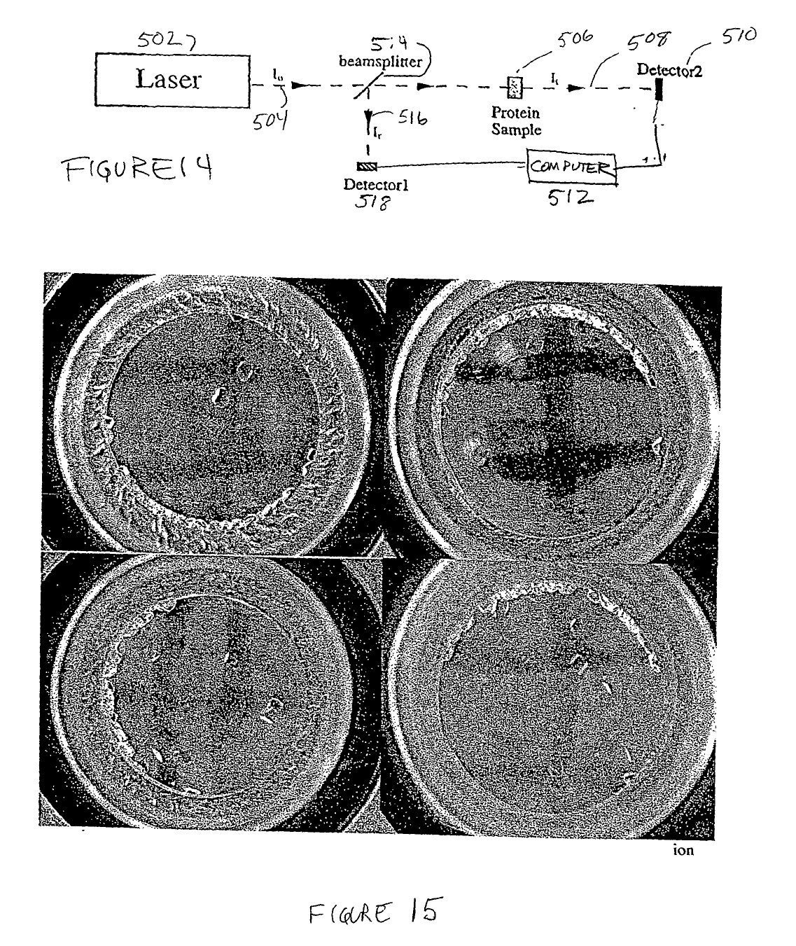

FIG. 15 shows typical images recorded of crystals grown in our crystallization chambers. The digital images were recorded with an Olympus DP-10 digital camera adjusted to capture images in Super High quality mode using a Nikon SMZ-U stereomicroscope operating in the transmitted mode. Illumination was obtained from a tungsten-halide lamp housed in the base of the microscope, and light was passed through a polarizer prior to illumination of crystallization chambers. Each crystallization chamber was placed dialysis membrane side up onto the microscope stage and a photomicrograph of the entire contents was recorded and mapped as a reference. The photomicrographs were taken through the dialysis membrane, the largest crystals shown were in the order of 400-600 micrometers. In a variant of this embodiment of the invention, instead of photographing through the dialysis membrane, the photographs are made through a clear window at the other end of the protein chamber.

Culturing Cells

Working with live cells requires maintaining the cell culture chambers at the optimal culture temperature of 37° C. In a diamagnetic environment, this is done by blowing warmed air through the magnet bore, with temperature monitored by thermocouples mounted in the magnet bore. The thermocouples feed temperature information to a computer-controlled variable heater on the air source.

For CHRF cell culture, dynamic dialysis unit chambers are adapted specifically to maintain optimal growth conditions. Culture conditions for CHRF cells inside closed chambers deteriorate rapidly. This results in extensive cell apoptosis and death within 24 hours. The adapted chambers allow constant exchange of medium to maintain optimal culture conditions over extended periods. The modified chambers have an inlet port into the 1 ml compartment and an outlet port from the 40 microliter well on the top of the chamber. The well of the chamber is isolated, e.g. covered with polyester mesh with 5 micrometer openings. This chamber configuration allows constant exchange of the culture medium (including high molecule weight serum components) without loss of the cells from the chambers.

Culture medium containing a suitable buffer, e.g. HEPES pH buffer (10 mM) is pumped continuously from the external syringe-pump component of the DCCS through tubing connected to the inlet port into the 1 ml chamber containing the cells. Medium is withdrawn or expelled at an equivalent rate through the mesh barrier, which passes the medium but retains the cells in the 1 ml chamber, into the 40 microliter cap compartment and out an outlet port to the cap of the chamber. The rate of medium exchange necessary to maintain constant pH and nutrient content of the medium surrounding the cells in the chambers can be determined empirically by a person of ordinary skill. Cells can be cultured for various periods of time e.g. from 12 hours to 96 hours in or out of a magnet.

CHRF cells grow in suspension but also adhere to substrates coated with various extracellular matrix components that comprise matrix structures surrounding tissues in the human body. Adherence of CHRF cells may be important for their ability to pinch off membrane-bound regions of their cytoplasm as blood platelets. To monitor adherence of the CHRF cells, the chambers are modified to mount a glass coverslip at the bottom of the 1 ml compartment. It is therefore possible to remove the coverslip with adhering cells at the end of the experiment and to process the coverslip for analysis by light microscopy of levitation effects on the structure of the cells.

Overall analysis of the cells cultured at various effective gravity in the magnet bore involves counting cells in suspension to monitor cell growth and division and recovering platelets produced from the cells by differential centrifugation. In addition, effects of levitation on the structure of cells adhering to the coverslip at the bottom of the chamber are analyzed by immunofluorescently localizing cytoskeletal proteins fixed and processed at the end of each experiment.

The apparatus of the invention permits important assays. Levitation promoting formation of platelets may be adaptable for production of platelets for medical use from primary megakaryocyte culture. Levitation inhibiting platelet production or having other deleterious effects on the growth or structure of the CHRF cells permits refinement of methods of wound healing in astronauts in space.

The invention also permits analysis of the effects of gravity on the activity of freshly acquired human blood platelets. Platelets play a major role in sealing wounds and clotting blood. Gravitational effects on freshly obtained platelets are monitored with a configuration of the DCCS reactant chambers similar to that described above. Since unactivated or ‘resting’ platelets are only 4-6 micrometers in diameter, the polyester mesh barrier covering the outlet port can be replaced with a MWCO of 300,000 dialysis membrane that retain the platelets in the chambers while allowing exchange of the medium. The Tyrode's solution in which the platelets are maintained contains only relatively low molecular weight components and flows freely through the dialysis membrane barrier.

The medium exchange capability in this case allows activation of the platelets with physiologically relevant ‘wound signals’ such as ADP or thrombin while the platelets are in the system, in or out of a magnet. Under normal circumstances, platelets respond rapidly to these wound signals with a programmed response that involves secretion of certain products and assembly of cytoskeletal structures. The assembly of cytoskeletal structures inside the platelets makes it possible for the platelets to spread on wound surfaces and produce force for blood clot retraction. Using the inventive instrumentation, one can monitor effects of levitation on both platelet-induced blood clots formed in the chambers and on platelets adhering to coverslips by immunolocalization of cytoskeletal and clot proteins using confocal microscopy in samples taken from the chambers at the end of each run.

These platelet experiments involve acclimating the platelets in the magnet for 4-24 hours before activation. Following activation, the run can continue for times from 15 minutes, to monitor immediate effects to 4 hours to monitor the effects on complete platelet spreading and blood clot formation and retraction.

To monitor effects of levitation on formation of protein macromolecular structures in vitro, the non-flow through reactant chamber configuration may be used (similar to protein crystallization), in which the inlet and outlet ports are both connected to the 1 ml compartment. The 40 microliter well in the cap of the chamber is filled with a solution containing e.g. the purified human platelet cytoskeletal proteins myosin and c-titin and covered by dialysis membrane (MWCO 30,000). The initial solution in the cap is at an ionic strength high enough to inhibit interaction of the proteins. Self-assembly of the protein macromolecular structures is initiated by pumping into the 1 ml chamber a lower ionic strength solution that promotes the self-assembly interaction e.g. of the myosin. Myosin-c-titin coassemblies form in the cap, once exchange occurs with a low ionic strength solution in the 1 ml chamber. The structure of the coassemblies can be assessed by collecting structures directly on sample grids and negatively staining the samples for visualization with electron microscopy. Effects of levitation on the amount of coassemblies produced can be determined by differential centrifugation, which separates assembled from unassembled proteins. Results of these experiments yields insight into the molecular basis for effects of levitation found for human cells and platelets, and also how to generate patterns of self-assembling protein for nanotechnology applications.

For each of these studies one can take advantage of the opportunities of continuous variation of field and effective gravity. A vertical assembly of growth chambers (chamber stack) can be constructed for symmetrical placement in the bore of the high field magnet. In the chamber stack the chambers can be horizontal with respect to the vertical direction of the magnetic field and the axis of the magnet bore. Hence each chamber is at a different g_{eff} value, and also a different magnetic field value. For a given magnetic field value, the upper chamber can be positioned for the g_{eff}=0 condition by adjusting the entire stack. It is important to note that the stack does not levitate. Rather, the cells in the specific chamber where g_{eff}=0 experience no net force, over a distance of less than 1 mm. Each cell in the stack samples a gradual variation of g_{eff} with position. Those cells above magnet center are at g_{eff}<g, whereas those below will be at g_{eff}>g. The center cell is at g_{eff}=g, and represents the control experiment where the magnetic field is present, but g_{eff}=g. A further parameter, which is variable, is the total magnetic field. It can be varied anywhere from about 16 to 33 tesla. This shifts the g_{eff}=(2 to 6) g and the g_{eff}=0 points further away from the center of the magnet. For fields less than 16 T the g_{eff}=0 condition cannot be maintained, but a finer variation for the condition 2 g<g_{eff}<g can be studied.

Further Embodiments

The present invention permits a large number of samples to be subjected to dynamic dialysis by which the concentrations of reagents to which the samples are exposed are changed in a controlled manner over time. By automatically monitoring the samples and rapidly responding to changes in their condition, the invention provides sensitive and independent control over the condition or state of each sample.

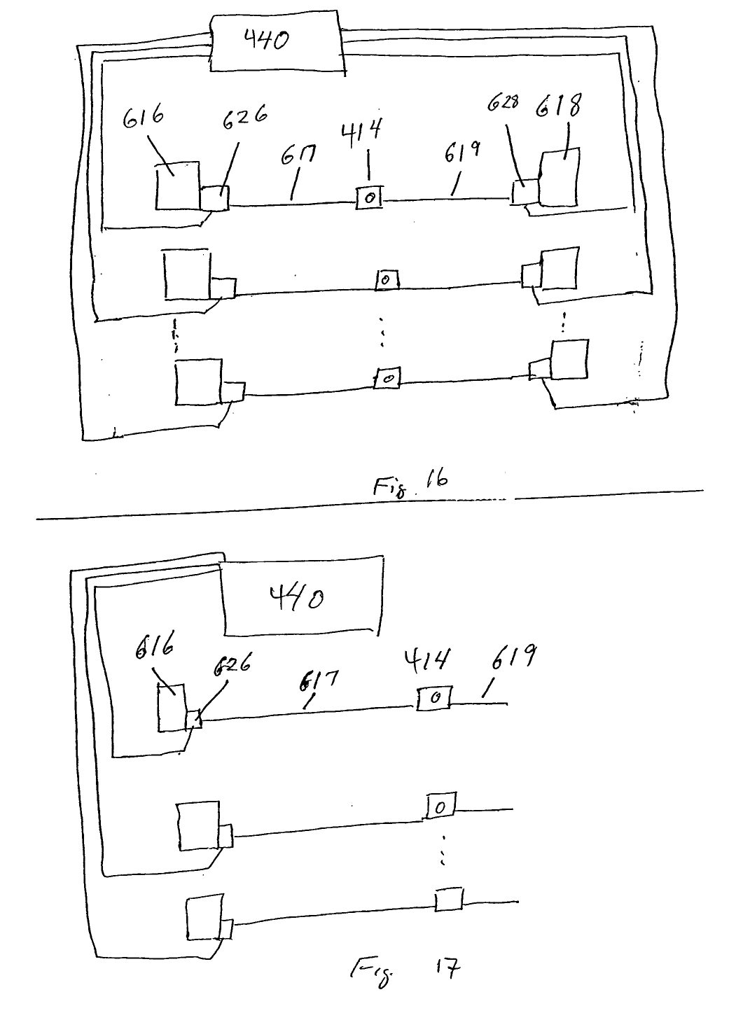

The invention can be made and practiced with wide variation in the number, arrangement, and connectivity of the diverse components. For example, in an alternative carousel embodiment of the apparatus illustrated in FIGS. 10-11, the pair of motor driven syringes connected to each dialysis unit can be replaced by a pair of solution reservoirs, each of which is connected to a pump that pumps solution between the reservoir and the reagent chamber of the dialysis unit. This configuration is schematically illustrated in FIG. 16A, wherein solution reservoir 616 and pump 626 are connected via tubing 617 to dialysis unit 414, and solution reservoir 618 and pump 628 are connected via tubing 619 to the dialysis unit. Controller 440 is operably connected to pumps 626 and 628, for control of the transfer of solution between the reservoir and the reagent chamber.

In certain embodiments, such as those for controlling crystallization, it is sometimes desirable to be able to reverse the flow of solution through the dialysis unit, for example, in order to reduce precipitant concentration and stabilize and promote the growth of a crystal one it has formed. In such a case, it is useful to employ a system that comprises a fluid transfer mechanism on each side of a dialysis unit, as e.g. in the embodiments of FIGS. 10 and 16.

Where there is no need to reverse the flow of reagent solution, an embodiment has only a single reagent reservoir is connected to each dialysis unit. This embodiment is schematically shown in FIG. 17, in which reagent reservoir 616 and pump 626 are connected to dialysis units 414 via tubing 617. In this embodiment, controller 40 controls the flow of solution from reservoir 616 to the dialysis units 414, and solution that is displaced from each dialysis unit 414 flows out through tubing 619 as waste.

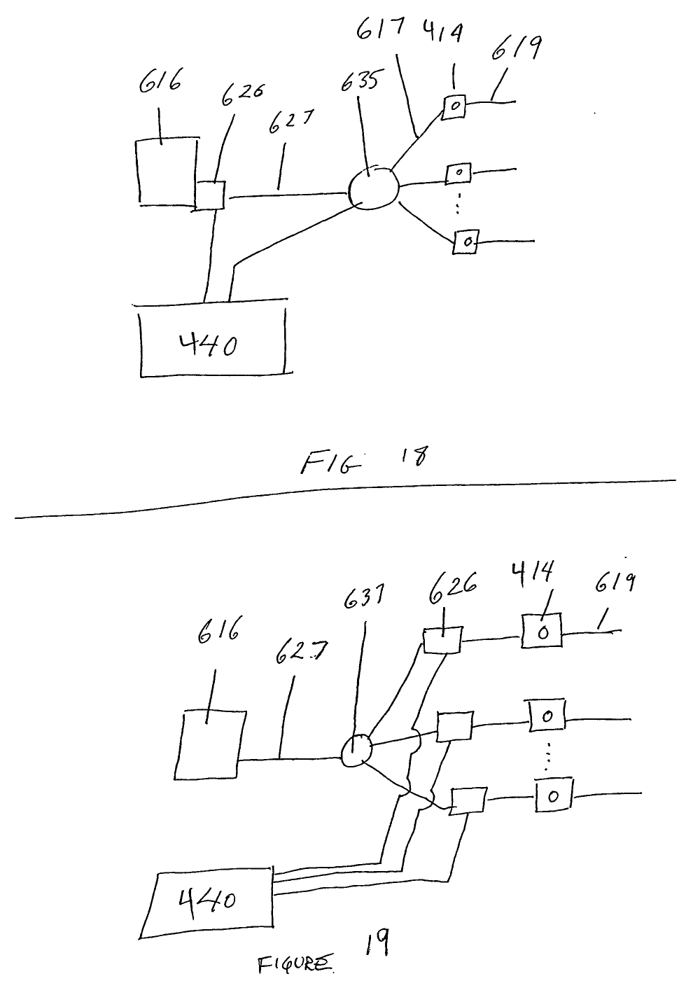

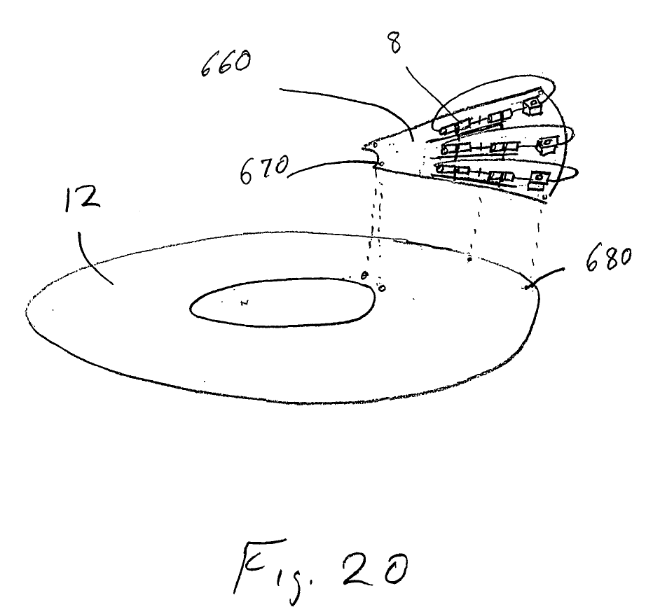

In other embodiments, the same reagent solution is transferred to two or more dialysis units, as shown in FIGS. 18 and 19. In FIG. 18, reagent reservoir 616 and pump 626 are connected via tubing 627 to valve 635, which is in turn operably connected via tubing 617 to a plurality of dialysis units 414. Valve 635 is a multi-way valve that takes in reagent solution through a port connected to tubing 627, and redirects the flow of said solution out through one or more of a plurality of ports that are each connected via a tubing 617 to a separate dialysis unit. Controller 440 is operably connected to pump 626 to control the flow of solution between reservoir 616 and valve 635, and is also operably connected to valve 635 to control the direction of flow from valve 635 to the dialysis units 414 to which it is connected.

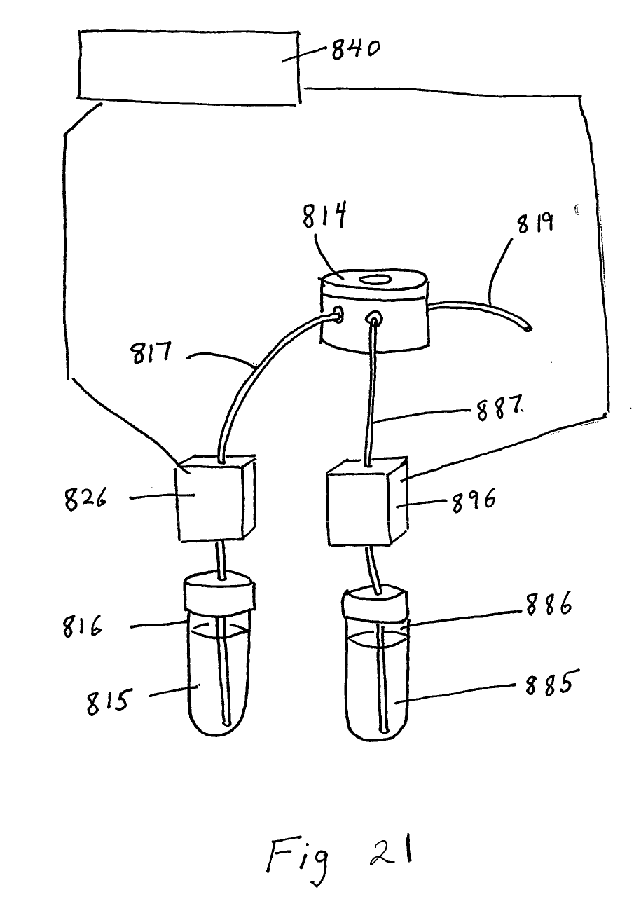

In FIG. 20, reagent reservoir 616 is connected via tubing 627 to valve 637, which is in turn connected via tubing 617 to each of several dialysis units 414, and a separate pump 626 pumps solution between valve 637 and each dialysis unit 414. Valve 637 is a multi-way valve that receives reagent solution through a port connected to tubing 627, and redirects the flow of said solution out through one of a plurality of ports that are each connected via tubing 167 to a separate dialysis unit 414. Controller 440 is operably connected to pump 626 to control the flow of solution between reservoir 616 and valve 635, and is also operably connected to valve 635 to control the direction of flow to the dialysis units 414 to which valve 635 is connected.

An alternative embodiment mounts the dialysis assemblies in subsets of wedge-shaped subsupports that can be attached to and detached from support disk 412 at will. FIG. 20 illustrates a wedge-shaped subsupport 660 on which several dialysis assemblies 408 are mounted. Connection points 670 on subsupport 660 line up with points 680 on disk 412 to facilitate attachment and detachment. For example, such connection points might be perforations in subsupport 660 and disk 412 which can be attached together with pins or screws. This embodiment may facilitate sample preparation.

In another embodiment, the dynamic dialysis units may be mounted on a movable platform, while the reagent reservoirs to which they are connected are fixed. Alternatively, all of the dialysis units might be fixed in position, and the sensor put onto a movable platform that is controlled to bring it into position to monitor the samples in the different units. In yet another embodiment, when cells are cultured in the chambers of the dialysis units, a separate chemical probe could be connected to each unit, e.g., for pH monitoring. Those skilled in the art would appreciate that many other embodiments of the present invention are possible.

As shown in FIG. 21, the inventive apparatus is readily adaptable to the requirements of membrane proteins, by manipulating detergent concentrations as well as precipitant concentrations. The solubility requirements of membrane proteins can be met by including different concentrations of detergent in the reagent solutions added to different units. Alternatively, an embodiment of the system can be used that employs dynamic dialysis units that are designed to permit two different reagent solutions to be added through separate conduits into the reagent chamber of a single dialysis unit. FIG. 21 illustrates such a dialysis unit. A reagent reservoir 816 containing a precipitant solution 815 is connected by tubing conduit 817 to a reagent chamber of dialysis unit 814, and another reagent reservoir 886 containing a detergent solution 885 is connected by tubing conduit 887 to the same reagent chamber of unit 814. Pump 826 is operably coupled to controller 840 and to conduit 817, and controller 840 controls pump 826 to transfer precipitant solution 815 from reservoir 816 into dialysis unit 814 via conduit 817. Similarly, pump 896 is operably coupled to controller 840 and to conduit 887, and controller 840 controls pump 896 to transfer detergent solution 885 from reservoir 886 into unit 814 via conduit 887. By exercising concerted control over pumps 826 and 896, any combination of concentrations of precipitant and detergent from reservoirs 816 and 886 can be established in the reagent chamber of dialysis unit 814.

The invention permits crystallization of hard-to-crystallize proteins which do not respond to any of the 200 some known screens. Using methods for dynamically controlling precipitant concentration, in combination with methods for sensitively monitoring and detecting the onset of nucleation, such as laser light scattering; and by (a) crystallizing in high magnetic fields to promote molecular alignment and provide reduced effective gravitational force mediated by magnetic levitation to eliminate sedimentation effects and (b) crystallizing in gels.

Alternatively, both the fluid inlet and drain may be connected to the same reagent reservoir. This simplifies and reduces costs dramatically, and operation is unaffected as the reagent concentration is not significantly affected by the relatively small volume of drainage into the much greater volume of the reservoir.

Hardware Aspects and Advantages

A small, detachable diamagnetic crystallization chamber permits easy switching and replacement, and use inside the bore of an NMR or resistive magnet for microgravity or levitation.

The improved hardware is:

compatible with all existing and planned refrigerator/incubators (thermal enclosure systems)

able to change precipitating concentration to arrive at the proper nucleation conditions slowly, smoothly, and accurately over any period of time—from minutes to months

able to conduct multiple crystallization in series with a predetermined gradient between each crystallization chamber

able to crystallize with protein quantities that range from 50 ul down to 1 ul

able to crystallize in high magnetic fields

able to support cell science research on the ground in high magnetic fields or in space

Precipitating Salt Concentration Measurements.

Altering in a gentle and continuous manner, the chemical and/or the physical properties of the system is a requirement in crystallization and a key feature of the DCCS. This may be accomplished by pushing a precise quantity of salt solution into the crystallization chamber and simultaneously drawing out the same quantity by means of creating a partial vacuum. To measure the salt concentration, monitor its rate of change and check its repeatability, an electric conductivity probe was developed. Its operation was based on building a microprobe that had two platinum tips that were emerged in the salt solution. Across these tips a square wave was applied; the measured current was a measure of the conductivity. Testing indicated that at high salt concentrations (50% of 100% saturated salt water and higher) the measurement became non-linear to the point where there was only a small difference between 50% and 60% salt concentrations. Since this is the range of concern for controlling the onset of nucleation and a redesign of the probe provided limited improvement alternate methods of determining the salt concentration were investigated.

Voltage Gated Membranes.

In the dialysis sack technique of crystallization the protein is contained in a dialysis sack and crystallization salts and buffer whose macromolecular size is smaller than the pore size of the dialysis membrane can enter the sack and bring the concentration of the protein solution to its crystallization point. The purpose of a voltage gated membrane is to have the properties of a dialysis membrane whose pore size can be electrically varied. This type of membrane was tested successfully.

Electrophoretic Techniques.

With the capabilities of the foregoing voltage gated membrane and using electric currents it is possible to use electrophoretic techniques and realize a compact crystallization system that has dynamic control capabilities and no moving parts or mechanical systems. The complete system can be placed on a chip by means of MEMS technology and a crystallization chamber using silicon wafer material.

Robotic Sample Loading and Membrane Installation.

By eliminating the time-consuming manual operations of preparing mixtures, and loading them in chambers, robotics improves test repeatability. The inventive apparatus also requires installing membranes. The membranes can be installed automatically 10 or 20 at a time instead of individually and the protein and precipitating solutions can be metered out by several automatic pipettes, to eliminate the most tedious and time consuming operations at a fraction of the cost.

Further Advantages.

Since the crystallization chamber can be detached from the system by lengthening the inlet and outlet capillary lines, it can be inserted in a high magnetic field and the effects of high magnetic field could be determined.

Since the crystallization chamber, proteins, salt solutions and cells are diamagnetic, levitation forces could be generated and effective gravitational forces ranging from several g's down to small values of g can be produced.

Since the DCCS can be used with a laser light scattering system, it is possible to study the onset of nucleation and crystal growth. The precipitating salt concentrations can be adjusted to better than ½ of 1% and the rate of change of concentration is computer controlled, permitting the crystallization dynamics to be studied in great detail. Similarly the DCCS can be used with other types of nucleation studies such as interferometers, microscope laser light scattering systems, and the glove box-size interferometer.

Since the crystallization chamber is detachable it can be used with a new state-of-the-art USAXS instrument with a high-intensity x-ray beam at the Advanced Photon Source at Argonne National Laboratory. The significance of this research is to provide a capability to monitor the earliest stages of aggregation, nucleation, and crystallization processes in protein for the purposes of controlling the growth process and the quality of the final crystals.

Nucleation Detection Techniques

The invention employs several nucleation detection techniques in its sensors for protein crystallization.

Scattering techniques, in particular, laser light scattering (LLS), both static and dynamic, small-angle X-ray scattering (SAXS), and small-angle neutron scattering (SANS), have been applied as primary, non-intrusive techniques to investigate different aspects of the crystallization of various proteins, especially water-soluble proteins.

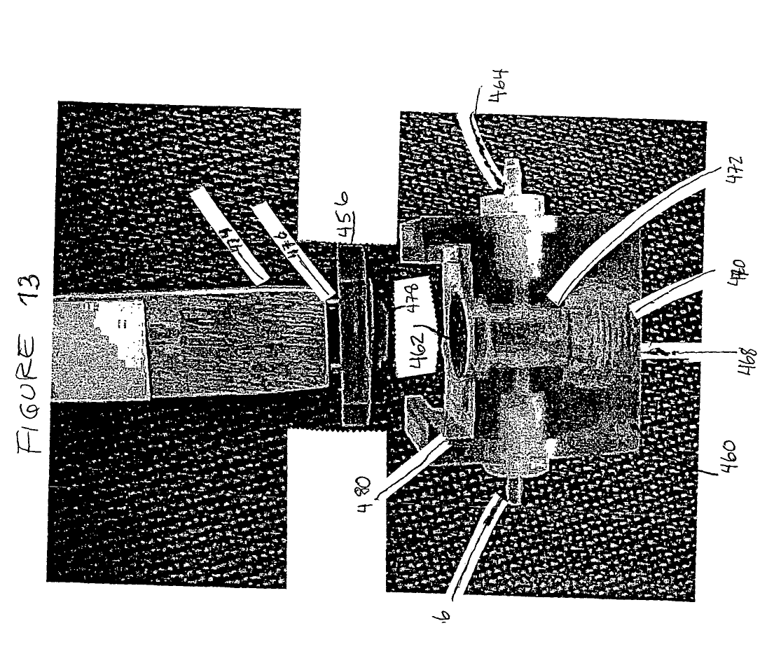

In static/light scattering, changes in the laser-transmission of transparent solutions can be used as a signature for changes in the structural properties of the solutions. FIG. 14 shows a schematic diagram of a simple setup that can be used for induction-time measurements. A laser 502 generates beam 504 of intensity, I (0), directed towards the sample 506 and the transmitted intensity, I(t), of beam 508 is measured with a light-sensitive detector 510, routed to computer controller 512. Since the runs are long due to the slow kinetics of the protein solution, the laser beam intensity fluctuations are monitored using a reference beam 516 of intensity I(r) generated from splitting the initial laser beam with a prism 514. Both signals, I(t), and I(r), are continuously fed to computer 512 through a GPIB board for storage. Plots of corrected I(t) vs time identify the induction time for the onset of observable crystallization. X-ray beams are more sensitive than laser-beams in the detection of small features, and thus the actual induction-time for X-ray is shorter.

While static light scattering permits transmittance/turbidity measurements, dynamic light scattering (DLS) can be used to measure the hydrodynamic size of the growing crystal (rn).

According to the invention the crystallization chamber is located in a location where it is accessible to an incoming laser light beam, and outputted scattered light can be readily accessed. To measure scattered light, for optimum signal to noise conditions, the signal that is orthogonal to the incoming laser beam is measured by the detector. A short optical path (−1 mm) between two windows of quartz would be ideal, but practical considerations dictate some compromises, eg. the design requires a leak proof chamber.

Protein crystallization has long suffered from not being able to produce repeatable test results. Major contributors are the cleanliness of the protein and unwanted variations in controlling the crystallization parameters.

Non-specific aggregation is extremely detrimental to the formation of crystals. In order for a crystal to grow it requires an initial ordered nucleus upon which to add additional molecules. What causes molecules to come together and arrange themselves in ordered arrogates (nuclei) rather than disordered ones (precipitate)? The process is not well understood but studies have shown that for aggregation to lead to crystals it must not occur prior to supersaturation. It is therefore important that the protein itself be free of aggregates prior to inducing supersaturation with crystallization precipitants.

The most frequent cause of non-specific aggregation are: 1) suboptimal protein solvent conditions, and 2) contamination by heterologous proteins. A great value of LLS is that the initial solvent conditions can be optimized quickly (minutes) and with very little protein (20 ul at a few mg/ml). The assay is non-invasive, i.e., the protein can be recovered. Information about the size homogeneity of a protein can be obtained from other methods but not with the speed or sensitivity levels of LLS.

Unwanted variations in the crystallization process arise when crystallization parameters (temperature, pH, precipitating concentrations and the desire rates of changes of these concentrations, etc.) vary in the crystallization chamber. The invention provides nucleation detection capability so that the protein condition can be checked before the crystallization process begins; and by being able to detect the onset of nucleation, the crystallization process can be optimized.

All publications, patents, and patent applications mentioned in the above specification, are incorporated herein by reference. Nothing herein is to be construed as an admission that the invention is not entitled to antedate such disclosure by virtue of prior invention. Various modifications and variations of the described methods and system of the invention will be apparent to those skilled in the art without departing from the scope and spirit of the invention. Although the invention has been described in connection with specific embodiments, it should be understood that the invention as claimed is not limited to such specific embodiments, and that various modifications of the described modes for carrying out the invention which are obvious to those skilled in the arts to which this invention pertains are intended to be within the scope of the following claims.

References

1. “New Opportunities in Science, Materials, and Biological Systems in the Low-Gravity (Magnetic Levitation) environment”, presented at the 44^{th} Conference on Magnetism & Magnetic Materials Conference on Nov. 15-18, 1999.

2. Beaugnon and R. Tournier, Nature 349, 470 (1991).

3. H. Goldstein, Classical Mechanics (Addison-Wesley, Reading).

4. J. H. van Vleck, The Theory of Electronic and Magnetic Susceptibilities (Oxford University Press, London, 1965).

5. A. Abragam, Principles of Nuclear Magnetism (Clarendon Press, Oxford, 1994).

6. Pobell, Matter and Methods at Low Temperatures (Springer Verlag, Berlin, 1991).

7. N. I. Wakayama, M. Ataka, and H. Abe, J. Crystal Growth 178, 653 (1997).

8. L. Stryer, Biochemistry (W. H. Freeman and Company, New York, 1995).

9. Sazaki, E. Yoshida, H. Komatsu, et al., J. Crystal Growth 173, 231 (1997).

10. M. Powers, in The McGraw-Hill Companies' Federal Technology Report, (1998), p. 10.

11. S. Weisgerberger, J. R. Helliwell, E. Weckert, et al., Acta Cryst. D51, 1099 (1995).

12. Maret and K. Dransfeld, in Strong and Ultrastrong Magnetic Fields and Their Applications, edited by F. Herlach (Springer-Verlag, Berin, 1985), Vol. 57, p. 143.

13. Eilertsen K J, Kazmierski S T, Keller T C S, III: Cellular titin localization in stress fibers and interaction with myosin II filaments in vitro. J.Cell Biol. 126: 1201-1210, 1994

14. Sims P J, Wiedmer T: The response of human platelets to activated components of the complement system. Immunol.Today 12: 338-342, 1991

15. Brooks J S, Cothem J A: Dynamical Behavior of Granular Matter in Low Gravity (Diamagnetic Levitation). J. Applied Physics. to be published 2000.

16. Brooks J S, Cothern J A: Diamagnetism and Magnetic Force: A New Laboratory for Granular Materials and Chaotic/Deterministic Dynamics. manuscripts submitted.

17. Sawicki, M. W., Ohno, S., Ghosh, D. (2000) Structure of pig20β-Hydroxysteroid Dehydrogenase with NADP+. In Preparation.

18. Sawicki, M. W., Weeks, D. R., Eyzaguirre, J., Ghosh, D. (2000) 0.85 Å Structure of Acetyl Xylan Esterase. In Preparation.

19. Sawicki, M. W., Natarajan, K., Margulies, D. H., Mariuzza, R. A. (2000) Crystal Structure of the C-type Lectin CD69 with Bound Saccharide: Implications into CD69's Ligand Specificity Submitted, Biochemistry.

20. Ghosh, D., Erman, M., Sawicki, M. W., Lala, P., Weeks, D. R., Li, N., Pangborn, W., Theil, D. J., Jornvall, H., Eyzaguirre, J. (1999) Determination of a Protein Structure by Iodination: The Structure of Iodinated Acetylxylan Esterase. Acta Cryst. D. 55, 779-784.

21. Sawicki, M. W., Ng, P. C., Burkhart, B. M., Pletnev, V. Z., Higashiyama, T., Osawa, Y., Ghosh, D. (1999) Structure of an Activity Suppressing Fab Fragment Raised Against Cytochrome P450 Aromatase: Insights into the Antibody Antigen Interactions. Mol. Immunology. 36, 423-432.

22. Sawicki, M. W., Erman, M., Puranen, T., Vihko, P., Ghosh, D. (1999) Structure of the Ternary Complex of Human 17β-Hydroxysteroid Dehydrogenase Type 1 with 3-Hydroxyestra-1,3,5,7 tetraen-17-one (equilin) and NADP+. PNAS. 96, 840-845.

23. Sawicki, M. W., Li, N., Ghosh, D. (1999) Equilin, Acta Cryst. C. 55, 425-427.

24. McPherson, Preparation and Analysis of Protein Crystals (J. Wiley & Sons, New York, 1982).

25. R. Piazza, J. Cryst. Growth, 415-423, 1999)

26. B. J. Ackerson et al., Phys. Rev., 6448-6460, 1995

27. Chernov, Physics Reports, 61-75, 1997

28. H. Durchschlag et al., J. Appl. Cryst., 822-831, 1991).

What is claimed is:

1. An apparatus comprising:
(a) at least one reagent reservoir,
(b) a plurality of dynamic dialysis units, connected fluidly in parallel to a reagent reservoir and each comprising:
(i) a reagent chamber connected via a first fluid conduit to the reagent reservoir;
(ii) a sample chamber having a fluid contact point with the reagent chamber; each unit having a second conduit;
(c) a fluid transfer mechanism that transfers fluid between the reagent reservoir and the reagent chamber via inlet, for each dynamic dialysis unit;
(d) at least one sensor sensing one or more physical or chemical attributes of a sample in the sample chamber of each unit, and producing a corresponding output signal;
(e) a main control system operably linked to said plurality of dynamic dialysis units, to said fluid transfer mechanism, and to said at least one sensor, comprising:
(i) a sensor control system that receives the output signal from the at least one sensor and controls the operation of the at least one sensor,
(ii) an analysis system that analyzes output signals received from the at least one sensor, and
(iii) a dynamic dialysis unit control system that independently controls the flow of reagent solutions between said reagent reservoir and said reagent chamber of each dynamic dialysis unit;
wherein said main control system independently controls the flow of reagent solution from said reagent reservoir to the reagent chambers of the dynamic dialysis units, and modifies the flow in feedback response to the output signal from the analysis system.

2. The apparatus of claim 1, wherein the sample is a protein and the sensor detects a stage of crystallization.

3. The apparatus of claim 1, further comprising a semipermeable membrane defining at the fluid contact point between the sample chamber and the reagent chamber of each dynamic dialysis unit.

4. The apparatus of claim 3, wherein said semipermeable membrane is a voltage-gated membrane and the permeability properties of the membrane are electrically controllable.

5. The apparatus of claim 1, further comprising a position control system that is operably connected to the main control system and controls the position of the sensor relative to the position of each of said dynamic dialysis units.

6. The apparatus of claim 5, further comprising at least one dialysis unit support structure that supports the sample chamber and the reagent chamber of each dynamic dialysis unit, and is operably connected to the position control system,
whereby the position of said support structure is controlled to place the sample chamber of a selected dynamic dialysis unit in position for the sensor to sense physical or chemical attributes of a sample in said sample chamber.

7. The apparatus of claim 6, wherein said support structure is a rotatable, circular disk to which the sample chamber and reagent chamber of each dynamic dialysis unit are attached in a circular array.

8. The apparatus of claim 6 wherein said support structure is a movable, x-y table to which said sample chamber and reagent chamber of each dynamic dialysis unit are attached in at least one row.

9. The apparatus of claim 5, wherein the position of at least a sensing portion of said sensor is controlled by the position control system to place said sensing portion in position to sense physical or chemical attributes of a sample in the sample chamber of a selected dynamic dialysis unit.

10. The apparatus of claim 1, wherein each of said dynamic dialysis units further comprises a transparent wall through which the interior of said sample chamber can be viewed.

11. The apparatus of claim 1, wherein said at least one sensor comprises a camera mounted on a microscope.

12. The apparatus of claim 1, wherein said at least one sensor measures one or more of static laser light scattering, dynamic laser light scattering, small-angle X-ray scattering, ultra-small-angle X-ray scattering, and small-angle neutron scattering, in the sample chamber of a selected dynamic dialysis unit.

13. The apparatus of claim 1 wherein said sensor comprises an interferometer.

14. The apparatus of claim 1 wherein said analysis system comprises a computer that is connected to said sensor and receives as input the sensor's output signal; and
wherein said analysis system processes said signal and produces an output signal corresponding to the state of said one or more physical or chemical attributes of the sample sensed by said sensor.

15. The apparatus of claim 1, further comprising at least one reservoir connected to the second fluid conduit of each dynamic dialysis unit.

16. The apparatus of claim 15, wherein the direction of flow of fluid between said reagent reservoir and the reagent chamber of each of said dynamic dialysis units is independently reversible for each dynamic dialysis unit.

17. The apparatus of claim 1, further comprising a second fluid transfer mechanism that transfers fluid between the reagent chamber and the reservoir connected to the second fluid conduit of each dynamic dialysis unit.

18. The apparatus of claim 17, wherein said first and second fluid transfer mechanisms are controllable to simultaneously transfer equal volumes of solution into and out of said reagent chamber.

19. The apparatus of claim 17,
wherein said reagent reservoir and said first fluid transfer mechanism comprise a first syringe, and said second reagent reservoir and said second fluid transfer mechanism comprise a second syringe;
wherein said apparatus further comprises supporting members that support the bodies of said first and second syringe so that they point in opposite directions with their positions relative to each other being fixed;
wherein the plungers of said first syringe and said second syringe are interlocked; and
wherein said first and second fluid transfer mechanisms further comprise at least one motor that operatively couples to the plungers of said paired syringes and is controllable by said dynamic dialysis unit control system.

20. The apparatus of claim 19,
wherein said first and second fluid transfer means further comprise:
(a) a slide rod that is disposed to slide in a direction parallel to the long axis of said first and second syringes, is attached to the interlocked plungers of said syringes, and is supported by said syringe supporting members; and
(b) a push rod that operatively couples to said slide rod and engages and is controllably moved back and forth by said motor.

21. The apparatus of claim 19,
comprising a separate set of said first and second syringes with interlocked plungers for each dynamic dialysis unit,
wherein said first syringe is fluidly coupled to the reagent chamber via said first conduit, and said second syringe is fluidly coupled to the reagent chamber via said second conduit, of each dynamic dialysis unit.

22. The apparatus of claim 19,
comprising a single motor that drives the interlocked plungers of the paired syringes of each of said dynamic dialysis units.

23. The apparatus of claim 19,
comprising for each dynamic dialysis unit a separate motor that is operatively coupled to the interlocked plungers of the paired syringes of said dynamic dialysis unit.

24. The apparatus of claim 1, wherein the volume of the sample chamber of a dynamic dialysis unit is from less than 1 to about 150 microliters.

26. The apparatus of claim 1, wherein said sample chamber, reagent chamber, and said first and second fluid conduits, are diamagnetic.

27. A method comprising:
(a) providing a reagent solution comprising at least one reagent in a first reagent reservoir;
(b) providing a solution comprising an initial reagent in a reagent chamber of each of a plurality of dynamic dialysis units comprising a reagent chamber and a sample chamber;
wherein said reagent chamber communicates via a first fluid conduit with said reagent reservoir, and has a second fluid conduit; and
wherein at least one first fluid transfer mechanism transfers fluid between said first reagent reservoir and the reagent chamber via said first conduit, for each dynamic dialysis unit;
(c) loading a sample solution comprising a sample into the sample chamber of each of said dynamic dialysis units;
wherein each of said dynamic dialysis units further comprises a semipermeable barrier between said reagent chamber and said sample chamber that contacts and separates said sample and reagent solutions in said unit;
(d) performing the following steps independently for each of said dynamic dialysis units:
(i) transferring a predetermined volume of reagent solution into the reagent chamber from said reagent reservoir, and simultaneously transferring an equivalent volume of solution out of the reagent chamber;
(ii) after a predetermined period of time following step (i), sensing the state of the sample in said sample chamber with at least one sensor that can sense one or more physical or chemical attributes of said sample in said sample chamber, and producing an output signal conveying the results of the sensing operation;
(iii) analyzing the output signals received from said at least one sensor, and determining if the sensor has detected a change in a physical or chemical attribute of said sample that is associated with transformation of said sample to a predetermined target state;
(iv) repeating steps (i) to (iii) above until it is determined in step (iii) that said sample is transformed into a sample having a predetermined target state; and
(v) independently controlling the flow of reagent solution between the first reagent reservoir and the reagent chamber of said dynamic dialysis unit containing a sample having a predetermined target state, in feedback response to the sensing of said state of said sample by the sensor.

28. The method of claim 27, wherein said semipermeable membrane is a voltage-gated membrane and the permeability properties of the membrane are electrically controllable.

29. The method of claim 27, wherein said step of transferring reagent solution is controlled by a dynamic dialysis unit control system that is operatively linked to said at least one first fluid transfer mechanism and independently controls the flow of reagent solutions between said first reagent reservoir and said reagent chamber, and between the reagent chamber and the second fluid conduit, of each dynamic dialysis unit.

30. The method of claim 27, wherein said fluid transfer comprises pumping.

31. The method of claim 27, comprising controlling the position of the sensor relative to the position of each of said dynamic dialysis units by a position control system.

32. The method of claim 31, wherein the sample chamber and the reagent chamber of each dynamic dialysis unit are supported by at least one support structure that is operably connected to the position control system, and
comprising controlling the position of said support structure by the position control system to place the sample chamber of a selected dynamic dialysis unit at the sensor.

33. The method of claim 32, wherein said support structure comprises a rotatable, circular disk to which the sample chamber and reagent chamber of each dynamic dialysis unit are attached, and comprising rotating the support structure.

34. The method of claim 32, wherein said support structure comprises a movable, x-y table to which said sample chamber and reagent chamber of each dynamic dialysis unit are attached in at least one row, comprising moving the x-y table in an x and/or y direction.

35. The method of claim 31, comprising positioning at least a sensing portion of said sensor by the position control system to sense the sample in the sample chamber of a selected dynamic dialysis unit.

36. The method of claim 27, wherein said step of analyzing the sensor's output signal comprises processing said signal and determining whether the state of the sample sensed by said sensor has changed its properties.

37. The method of claim 27, comprising:
(i) independently controlling the flow of reagent solutions between said first reagent reservoir and said reagent chamber, and between the reagent chamber and the second fluid conduit, of each dynamic dialysis unit,
(ii) controlling the position of the sensor relative to the position of each of said dynamic dialysis units;
(iii) controlling the operation of said sensor,
(iv) analyzing output signals produced by said sensor, and
(v) feedback controlling the dynamic dialysis unit control system in response to lie output signal from the analysis system.

38. The method of claim 37, wherein said main control system automatically and independently controls the flow of reagent solution between said first reagent reservoir and the reagent chamber of a dynamic dialysis unit in feedback response to the output signal from the analysis system corresponding to the state of said one or more physical or chemical attributes of the sample sensed by said sensor.

39. The method of claim 35, comprising reversing the direction of fluid flow.

40. The method of claims 27, comprising transferring fluid between said second reagent reservoir and the reagent chamber via said second conduit, for each dynamic dialysis unit;
wherein said step of transferring reagent solution into and out of the reagent chamber of each dynamic dialysis unit is independently controlled by a dynamic dialysis unit control system that is operatively linked to said first and second fluid transfer mechanisms,
said dynamic dialysis unit control system controlling said first and second fluid transfer mechanisms to simultaneously transfer equal volumes of reagent solution between said first reagent reservoir and the reagent chamber, and between the reagent chamber and said second reagent reservoir, of each dynamic dialysis unit.

41. The method of claim 27, wherein the sensing comprises viewing, the sample chamber through a transparent wall.

42. The method of claim 27, comprising crystallizing sample molecules with a precipitating reagent and said predetermined target state is nucleation of a crystal of said sample molecules.

43. The method of claim 42, wherein said sample molecules comprise a protein.

44. The method of claim 42, wherein said at least one sensor comprises a camera mounted on a microscope, said sensing step comprises obtaining a photographic image of a magnified view of the interior of a sample chamber.

45. The method of claim 42, wherein said sensing step comprises measuring one or more of static laser light scattering, dynamic laser light scattering, small-angle X-ray scattering, ultra-small-angle X-ray scattering, and small-angle neutron scattering, by the sample solution in the sample chamber of a selected dynamic dialysis unit.

46. The method of claim 42, wherein said sensing step comprises using an interferometer to measure variations in density of the sample solution in the sample chamber of a selected dynamic dialysis unit.

47. The method of claim 27, wherein said sample comprises a crystallized protein, said reagent solution comprises heavy atoms, and said predetermined target state comprises the binding of protein molecules of said crystal to said heavy atoms.

48. The method of claim 27, wherein said sample comprises a crystallized protein, said reagent solution comprises ligand molecules that bind to a molecule of said protein, and said predetermined target state comprises the binding of said crystallized protein molecules to said ligand molecules.

49. The method of claim 27, wherein said sample comprises a crystallized protein, said reagent solution comprises drug molecules that bind to a molecule of said protein, and said predetermined target state comprises the binding of said crystallized protein molecules to said drug molecules.

50. The method of claim 27, wherein said sample comprises cells, said at least one reagent solution comprises cell culture medium, and further comprises a reagent to be tested for its effect on said cells, and said predetermined target state is a change in at least one of the growth pattern, state of differentiation, metabolism, or physiology, of said cells in response to said reagent.

51. The method of claim 50, wherein said reagent to be tested for its effect on said cells is a drug.

52. The method of claim 50, wherein said cells are cancer cells or blood cells.

53. The method of claim 50, wherein said sensing step comprises obtaining a photographic image of a magnified view of the cells in the interior of a sample chamber.

54. The method of claim 50, wherein said sensing step comprises assaying reagent solution of the reagent chamber to detect a chemical signal produced by said cells in response to said reagent.

55. A method according to claim 27 wherein:
the reagent solution is a precipitating solution,
the sample solution comprises crystallizing molecules,
the semipermeable barrier is a dialysis membrane, and
the sensing comprises sensing at least one of crystal nucleation, crystal growth, crystal stability, and crystal appearance, in said sample chamber, and producing an output signal conveying the results of the sensing operation.

56. The method of claim 55, wherein the reagent chamber of each dynamic dialysis unit is connected via its second fluid conduit to a second reagent reservoir containing a second reagent solution in which the concentration of reagent is different than its concentration in said first reagent solution.

57. The method of claim 56, wherein a second fluid transfer mechanism transfers fluid between said second reagent reservoir and the reagent chamber via said second conduit, for each dynamic dialysis unit;
wherein said first and second fluid transfer mechanisms are controlled to simultaneously transfer equal volumes of reagent solution between said first reagent reservoir and the reagent chamber, and between the reagent chamber and said second reagent reservoir, of each dynamic dialysis unit; and
wherein said step of transferring reagent solution into and out of the reagent chamber of each dynamic dialysis unit by said first and second fluid transfer mechanisms is independently controlled for each dynamic dialysis unit.

58. The method of claim 56, wherein the direction of fluid flow between said first and second reagent reservoirs and the reagent chamber of each dynamic dialysis unit is independently reversible for each dynamic dialysis unit

59. The method of claim 58,
wherein said sample comprises molecules to be crystallized, said at least one reagent is a precipitant, and said predetermined target state is nucleation of a crystal of said molecules to be crystallized;
wherein the concentration of precipitant in said first reagent reservoir is greater than its concentration in said second reagent reservoir, and
wherein the feedback response to sensing nucleation in the sample chamber of a dynamic dialysis unit comprises reversing the direction of flow of reagent solution between said first and second reagent reservoirs and the reagent chamber of said dynamic dialysis unit.

60. The method of claim 57,
wherein said first reagent reservoir and said first fluid transfer mechanism comprise a first reagent syringe, and said second reagent reservoir and said second fluid transfer mechanism comprise a second reagent syringe;
wherein the bodies of said first and second reagent syringes are supported by a syringe mount to point in opposite directions with their positions relative to each other being fixed;
wherein the plungers of said first syringe and said second syringe are interlocked;
wherein each dynamic dialysis unit is connected to a separate set of said first and second reagent syringes with interlocked plungers;
wherein said first reagent syringe is operably coupled to the reagent chamber via said first conduit, and said second reagent syringe is operably coupled to the reagent chamber via said second conduit, of each dynamic dialysis unit; and
wherein said first and second fluid transfer mechanisms further comprise at least one motor that operatively couples to the plungers of said paired syringes; and
wherein the controlled operation of said motor results in transfer of fluid between said first and second reagent syringes and the reagent chamber of the dynamic dialysis unit to which said syringes are connected.

61. The method of claim 60,
comprising activating a slide rod that is disposed to slide in a direction parallel to the long axis of said paired first and second reagent syringes, is attached to said clamp that clamps together the plungers of said syringes, and is supported by said syringe supporting members.

62. The method of claim 61,
wherein said plurality of dynamic dialysis units are attached in a circular array to a rotatable, circular disk, each dynamic dialysis unit being attached proximal to the outer edge of said disk, the circular center of said disk being removed;
wherein said syringe supporting members are affixed to the surface of said disk so that said paired reagent syringes are radially oriented on said disk,
whereby the fluid-transferring end of the first reagent syringe of each syringe pair is positioned proximate to the dynamic dialysis unit to which it is attached, and the corresponding end of the second reagent syringe of said pair is pointed toward the center of the disk;
wherein said linear actuator motor is fixed in the circular space in the center of said disk so that said threaded rod is disposed to operatively couple to the slide rod that is attached to the interlocked plungers of the paired reagent syringes before which said motor is positioned; and
wherein a selected volume of reagent solution is transferred from said first reagent syringe into the reagent chamber of a selected dynamic dialysis unit, with simultaneous transfer of an equal volume of regent solution from the reagent chamber to said second reagent syringe, by:
(a) controlling a disk rotating motor to rotate said disk so that said threaded rod is disposed to operatively couple to the slide rod that is attached to the plungers of the reagent syringes of said selected dynamic dialysis unit; and
(b) controlling said linear actuator motor so that said threaded rod operatively couples to said slide rod and engages and is controllably moved forward by said motor to effect the transfer of said selected volume of reagent solution into and out of said reagent chamber.

63. An apparatus comprising:
(a) at least one means for containing a reagent solution comprising at least one reagent;
(b) a plurality of means for dynamically dialyzing a sample, each comprising:
(i) means for containing a sample solution;
(ii) means for controlledly contacting said reagent solution with the sample solution, whereby at least a component of said reagent solution is selectively transferred from the reagent solution to the sample solution, or a component of said sample solution other than the sample is selectively transferred from the sample solution to the reagent solution;
(c) at least one means for transferring fluid from the reagent solution containing means to said means for placing the reagent solution in controlled contact with the sample containing means, and at least one means for transferring fluid away from said means for placing the reagent solution in controlled contact with the sample containing means, for each dynamic dialysis means;
(d) at least one means for sensing a change in one or more physical or chemical attributes of the sample in the sample containing means, and for producing an output signal;
(e) means for dynamically controlling the concentration of said at least one reagent in each sample containing means over time, comprising:
(i) means for independently controlling the flow of reagent solution between said reagent containing means and the means for placing the reagent solution in controlled contact with the sample containing means, of each of said dynamic dialysis means;
(ii) means for analyzing output signals received from said sensor means for each of said dynamic dialysis units, and
(iii) means for modifying the flow of reagent solutions of each of said dynamic dialysis units in response to said output signals received from said sensor means.

64. A method for independently controlling dynamic, reagent-induced transformations of multiple samples, comprising:
(a) a step for introducing a reagent solution comprising at least one reagent into a first reagent reservoir;
(b) a step for introducing a solution comprising said reagent into a reagent chamber of each of a plurality of dynamic dialysis units comprising a reagent chamber and a sample chamber;
wherein said reagent chamber communicates via a first fluid conduit to said reagent reservoir, and further communicates with a second fluid conduit; and
wherein at least one first fluid transfer mechanism transfers fluid between said first reagent reservoir and the reagent chamber via said first conduit, for each dynamic dialysis unit;
(c) a step for introducing a sample solution comprising a sample into the sample chamber of each of said dynamic dialysis units;
wherein each of said dynamic dialysis units further comprises a semipermeable barrier between said reagent chamber and said sample chamber that contacts and separates said sample and reagent solutions in said unit;
(d) independently performing for each of said dynamic dialysis units:
(i) a step for transferring a predetermined volume of reagent solution into the reagent chamber from said reagent reservoir, and simultaneously transferring an equivalent volume of solution out of the reagent chamber;
(ii) a step for detecting a change in a physical or chemical attribute of said sample that is associated with transformation of said sample into a sample having at least one predetermined target state;
(iii) a step for independently controlling the flow of reagent solution between the first reagent reservoir and the reagent chamber of said dynamic dialysis unit containing a sample having a predetermined target state, in feedback response to the sensing of said state of said sample by the sensor.

65. The method of claim 64, wherein said sample comprises molecules to be crystallized, said at least one reagent is a precipitant, and said predetermined target state is nucleation of a crystal of said molecules to be crystallized.

66. The method of claim 65, wherein said molecules to be crystallized are molecules of at least one protein.

67. A method for independently controlling dynamic, reagent-induced transformations of multiple samples of cultured cells comprising
(a) placing a reagent solution comprising cell culture medium comprising nutrients required by the cells and a reagent of interest into a first reagent reservoir;
(b) placing cell culture medium comprising nutrients required by the cells into a reagent chamber of each of a plurality of dynamic dialysis units comprising a reagent chamber and a sample chamber;
wherein said reagent chamber communicates via a first fluid conduit to said reagent reservoir, and further communicates with a second fluid conduit; and
wherein at least one first fluid transfer mechanism transfers fluid between said first reagent reservoir and the reagent chamber via said first conduit, for each dynamic dialysis unit;
(c) placing cell culture medium comprising nutrients required by the cells into the sample chamber of each of said dynamic dialysis units, and inoculating said chambers with cells;
wherein each of said dynamic dialysis units comprises a semipermeable barrier between said reagent chamber and said sample chamber that contacts and separates said cell-containing solution in said sample chamber from said cell medium in said reagent chamber in said unit; and
(d) performing the following steps independently for each dynamic dialysis unit:
(i) transferring a predetermined volume of reagent solution into the reagent chamber from said reagent reservoir, and simultaneously transferring an equivalent volume of solution out of said reagent chamber and into said second conduit;
(ii) after a predetermined period of time following step (i), sensing the state of the cells in said sample chamber with at least one sensor that can sense a change in one of the growth pattern, state of differentiation, metabolism, or physiology, of said cells in said sample chamber, and producing an output signal conveying the results of the sensing operation;
(iii) analyzing the output signals received from said at least one sensor, and determining if the sensor has detected a change in said cells that is associated with said cells being transformed to have at least one predetermined target state;
(iv) repeating steps (i) to (iii) above until it is determined in step (iii) that said cells are transformed to have a predetermined target state; and
(v) independently controlling the flow of reagent solution between the first reagent reservoir and the reagent chamber of said dynamic dialysis unit containing a sample having said at least one predetermined target state, in feedback response to the sensing of said state by the sensor.

68. The method of claim 67 comprising positioning at least one of said sample chambers containing said cells in an effective gravitational field of from zero (levitation) to twice Earth's gravity (2 g), so that said cells are cultured in said effective gravitational field.

69. The method of claim 68 wherein said effective gravitational field of from zero (levitation) to twice Earth's gravity is produced by diamagnetism in the environment within a superconducting magnet.

70. The method of claim 68 comprising positioning said sample chamber containing said cells in a gravitational field that is less than that of Earth's gravity (1 g), so that said cells are cultured in said reduced gravitational field.

71. The method of claim 68 wherein said gravitational field that is less than that of Earth's gravity (1 g) is a gravitational field in space.

72. A method for culturing cells comprising
(a) placing reagent solution comprising cell culture medium comprising nutrients required by the cells and a reagent of interest into a first reagent reservoir;
(b) placing cell culture medium comprising nutrients required by the cells into a reagent chamber of a dynamic dialysis unit, wherein said reagent chamber communicates via a first fluid conduit to said reagent reservoir, and further communicates with a second fluid conduit; and
wherein at least one first fluid transfer mechanism transfers fluid between said first reagent reservoir and the reagent chamber via said first conduit, of said dynamic dialysis unit;
(c) placing cell culture medium comprising nutrients required by the cells into a sample chamber of a dynamic dialysis unit, and inoculating said chamber with cells;
wherein said dynamic dialysis unit comprises a semipermeable barrier between said reagent chamber and said sample chamber that contacts and separates said cell-containing solution in said sample chamber from said cell medium in said reagent chamber; and
(d) performing the following steps:
(i) transferring a predetermined volume of reagent solution into the reagent chamber from said reagent reservoir, and simultaneously transferring an equivalent volume of solution out of said reagent chamber and into said second conduit;
(ii) after a predetermined period of time following step (i), sensing the state of the cells in said sample chamber with at least one sensor that can sense a change in one of the growth pattern, state of differentiation, metabolism, or physiology, of said cells in said sample chamber, and producing an output signal conveying the results of the sensing operation;
(iii) analyzing the output signals received from said at least one sensor, and determining if the sensor has detected a change in said cells that is associated with said cells being transformed to have at least one predetermined target state;
(iv) repeating steps (i) to (iii) above until it is determined in step (iii) that said cells are transformed to have a predetermined target state; and
(v) controlling the flow of reagent solution between the first reagent reservoir and the reagent chamber of said dynamic dialysis unit containing a sample having said at least one predetermined target state, in feedback response to the sensing of said state by the sensor.

73. A method for culturing cells comprising
(a) placing reagent solution comprising cell culture medium comprising nutrients required by the cells and a reagent of interest into a first reagent reservoir;
(b) placing cell culture medium comprising nutrients required by the cells into a sample chamber of a flow-through cell culture unit,
wherein said sample chamber communicates via a first fluid conduit to said reagent reservoir, and further communicates through a portal with a second fluid conduit;
wherein a semipermeable membrane separates said sample chamber from said portal communicating with said second fluid conduit; and
wherein at least one first fluid transfer mechanism transfers fluid between said first reagent reservoir and the sample chamber via said first conduit;
(c) inoculating said sample chamber with cells; and
(d) transferring a predetermined volume of reagent solution into the sample chamber from said reagent reservoir, and simultaneously transferring an equivalent volume of solution out of said sample chamber and into said second conduit.

74. The method of claim 73, further comprising,
(i) after a predetermined period of time following step (d), sensing the state of the cells in said sample chamber with at least one sensor that can sense a change in one of the growth pattern, state of differentiation, metabolism, or physiology, of said cells in said sample chamber, and producing an output signal conveying the results of the sensing operation;
(ii) analyzing the output signals received from said at least one sensor, and determining if the sensor has detected a change in said cells that is associated with said cells being transformed to have at least one predetermined target state;
(iii) repeating step (d), followed by steps (i) and (ii) above, until it is determined in step (ii) that said cells are transformed to have a predetermined target state; and
(iv) controlling the flow of reagent solution between the first reagent reservoir and the sample chamber in feedback response to the sensing of said state by the sensor.

75. The apparatus of claim 1, wherein said second fluid conduit is connected to the reagent reservoir.
